(19) United States
(12) Patent Application Publication
(10) Pub. No.: US 2016/0237992 A1
(43) Pub. Date: Aug. 18, 2016

(54) Gravity Motor

(71) Applicant: Jacob W. Chicoski, Warrington, PA (US)

(72) Inventor: Jacob W. Chicoski, Warrington, PA (US)

(21) Appl. No.: 15/046,271

(22) Filed: Feb. 17, 2016

Related U.S. Application Data
(60) Provisional application No. 62/117,079, filed on Feb. 17, 2015.
(60) Provisional application No. 62/152,512, filed on Apr. 24, 2015.
(60) Provisional application No. 62/222,283, filed on Sep. 23, 2015.

(51) Int. Cl. F03G 3/00; H02K 7/18

(52) U.S. Cl. CPC F03G 3/00; H02K 7/1853; Y10S 74/09; F03G 7/10

(57) ABSTRACT

A gravity motor configured to generate rotational torque is provided. The gravity motor may include a primary axle supported by a frame structure. A primary load wheel may be positioned on the primary axle. Arms with slots extending from a central location may be attached to each side of the primary load wheel. The arms may allow weights to slide along the primary load wheel. A plurality of rotatable drive members may be fixed to corresponding transfer sprocket axles such that one end of the transfer sprocket axles is rotatably mounted to the frame structure. A plurality of weight attachment units are affixed to transfer sprockets in an arrangement such that the weight attachment units are configured to hook weights sliding along the primary load wheel. The configuration of the weights enable the gravity motor to convert gravitational potential energy of the weights to rotational torque of the primary axle.

### FIELD OF THE INVENTION

The present invention relates generally to machines for generating power. More particularly, the present invention relates to such a machine that converts gravitational potential energy into rotational kinetic energy, which can then be converted into electricity via an electric generator or other means.

### BACKGROUND OF THE INVENTION

Generation of electrical energy is a well known and established field. In particular, motors and other machines for converting a source of input energy to an output in the form of rotational torque that is delivered through an output shaft have been available for many years. The input energy for such machines has been provided by people, animals, moving water, the sun, blowing wind, fossil fuels, nuclear materials and a variety of other sources. In recent times, there has been a push for cleaner and renewable energy sources like solar and wind power in light of research that suggests certain traditional energy sources, namely fossil fuels, have harmful environmental impacts. The present invention seeks to use gravity as sustainable, clean energy input for a rotational power generation machine. Specifically, the present invention is a rotational machine, referred to as a gravity motor, for converting gravitational potential energy into rotational kinetic energy, which can then be converted into electricity via an electric generator or alternator, as well as a vacuum/blower via a fan or turbine. It can be used to mechanically power a pump, propeller, wheel, gear, sprocket, and any combination of such components via an output shaft. Further, rechargeable batteries may be incorporated with the system to allow for the storage of excess power to be used at a later time or when needed, such as during peak operating hours. The gravity motor can be linked to more than one matching gravity motor through a single primary shaft/axle, increasing the total amount of output torque. The gravity motor can be of any size, with it being larger or smaller in scale. Larger gravity motors can produce more torque and vice versa. Additionally, the gravity motor can be used in conjunction with a sealed container to allow for various monitoring systems and attachments to be used with the motor.

### SUMMARY OF THE INVENTION

An objective of the present invention is to convert gravitational potential energy into rotational kinetic energy which can further be converted into electricity. Another objective of the present invention is to provide a system to generate electricity using gravity as a sustainable, clean energy input for a rotational power generation machine.

In accordance with the objectives of the invention, a gravity motor is configured to generate rotational torque. The gravity motor is supported on a platform, a base, level ground, or other flat surface by a frame structure comprising frame plates, vertical frame posts, and horizontal and diagonal braces. The frame plates support a primary axle. A primary load wheel is positioned on the primary axle such that the primary load wheel is located equidistant from each of the frame plates supporting the primary axle. Arms with slots extending from a central location are attached to each side of the primary load wheel such that the arms are located between frame plates and the primary load wheel. The arms allow weights to slide along the primary load wheel.

A plurality of rotatable drive members are fixed to corresponding transfer sprocket axles such that one end of the transfer sprocket axles is rotatably mounted to a frame plate via flange mounted bearings. A plurality of weight attachment units are affixed to transfer sprockets in an arrangement such that the weight attachment units are configured to hook weights sliding along the primary load wheel. The configuration of the weights enable the gravity motor to convert gravitational potential energy of the weights to rotational torque of the primary axle. The primary axle can be operatively coupled to an electric generator configured to generate electricity based on rotary motion of the primary axle.

The invention disclosed herein provides for alternative configurations of the gravity motor comprising a primary load wheel. The alternative configurations comprise a plurality of arrangements of weight attachment units configured to carry a plurality of weights. A plurality of transfer pegs are configured to attached with the plurality of weights. The plurality of transfer pegs are evenly spaced along the circumference of each of the weight attachment unit and the primary load wheel. The weights are configured to be transferred between the weight attachment unit and primary load wheel such that through action of gravity, the plurality of weights provide a driving force to generate rotational torque about the primary axle. Rotatable drive members along with corresponding transfer sprocket axles are arranged to convert the driving force to rotational torque about the primary axle.

### BRIEF DESCRIPTION OF THE DRAWINGS

FIG. 1 is a perspective view of the preferred embodiment of the gravity motor, constructed in accordance with the present invention;

FIG. 2 is a front elevational view thereof;

FIG. 3 is a rear elevational view thereof;

FIG. 4 is a right side elevational view thereof;

FIG. 5 is a left side elevational view thereof;

FIG. 6 is a top plan view thereof;

FIG. 7 is a bottom plan view thereof;

FIG. 8 is an alternative perspective view thereof showing components positioned on the opposing side of the gravity motor;

FIG. 9 is a rear elevational partial cross section view thereof;

FIG. 10 is a perspective view of the alternative embodiment of the gravity motor;

FIG. 11 is an alternative perspective view thereof showing components positioned behind one frame plate, which is denoted by broken lines;

FIG. 12 is a right side elevational view thereof;

FIG. 13 is a partial cross section view thereof;

FIG. 14 is a simplified blocking diagram of the alternative embodiment gravity motor showing connections between major components thereof;

FIG. 15 is a simplified blocking diagram of the alternative embodiment gravity motor showing connections between major components thereof with an added drive chain tensioner;

FIG. 16 is a perspective view of another embodiment showing the additions of the flange mount brackets, belt driven generator and counterweights;

FIG. 17 is a right side elevational view thereof showing the additions of the flange mount brackets, belt driven generator, oil over-flow tanks, counterweights and turbine attachment;

FIG. 18 is a perspective view of the alternative counterweight system integrated onto the weight attachment chain;

FIG. 19 is a perspective view of the alternative counterweight system;

FIG. 20 is a front elevational view thereof;

FIG. 21 is a top plan view thereof;

FIG. 22 is a perspective view of yet another embodiment of the counterweight system integrated onto the weight attachment chain;

FIG. 23 is a perspective view of the second alternative embodiment of the counterweight system;

FIG. 24 is a front elevational view thereof;

FIG. 25 is a top plan view thereof;

FIG. 26 is a perspective view of the sealed container, showing the brake levers, turbine hole, relief gate, grease fitting extensions and sensors;

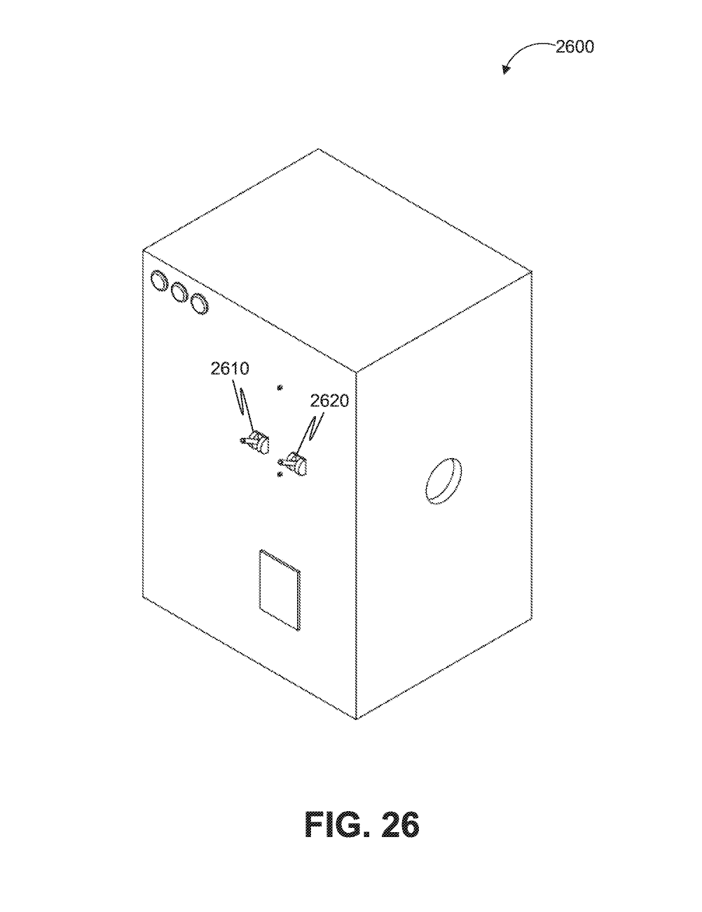

FIG. 27 is a front elevational view of the sealed container;

FIG. 28 is a rear elevational view of the seal container;

FIG. 29 is a left side elevational view of the sealed container;

FIG. 30 is a left side elevational view of the sealed container with a gravity motor enclosed;

FIG. 31 is a front elevational view of the sealed container with a gravity motor enclosed;

FIG. 32 depicts a plurality of gravity motors attached by the primary axle; and,

FIG. 33 depicts how the plurality of gravity motors may be controlled through software with the sealed container omitted.

### DETAIL DESCRIPTION OF THE INVENTION

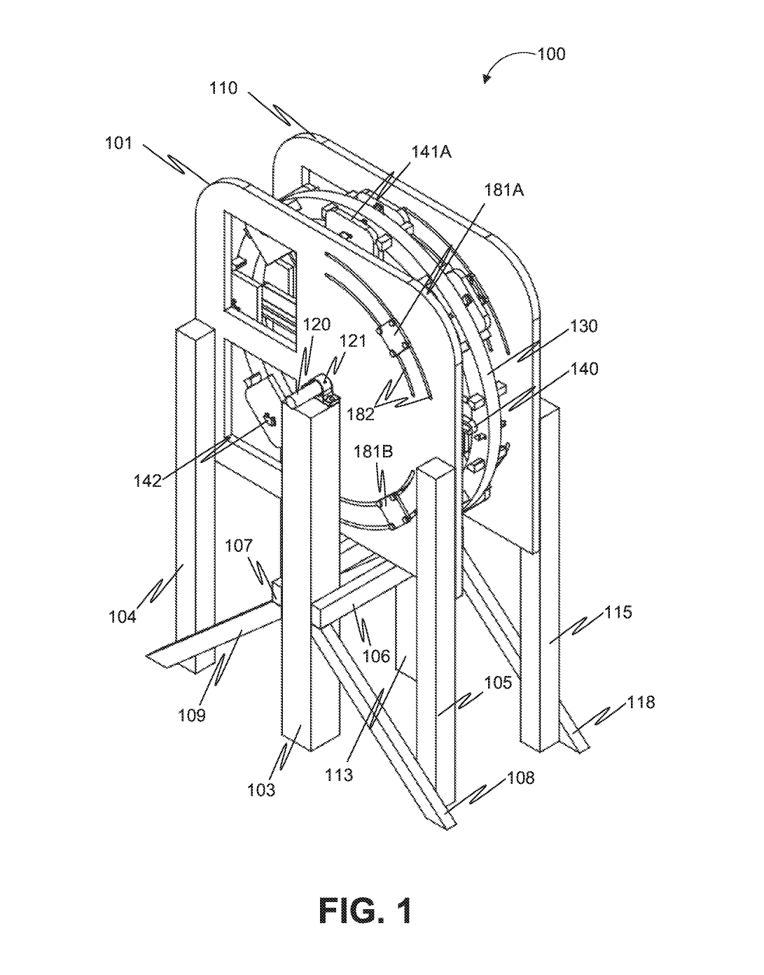

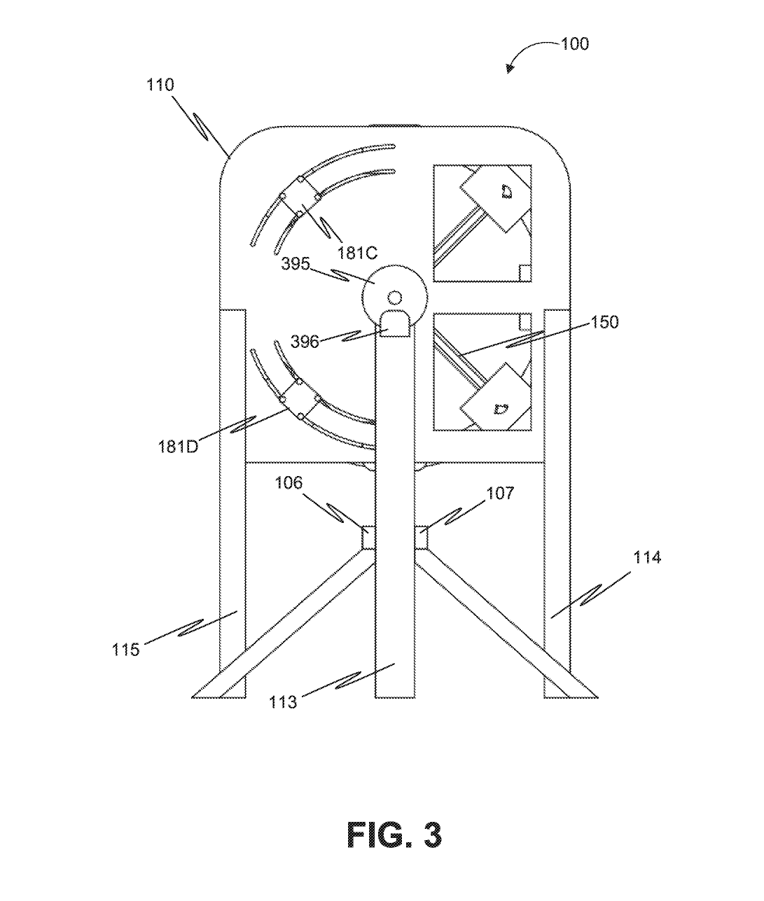

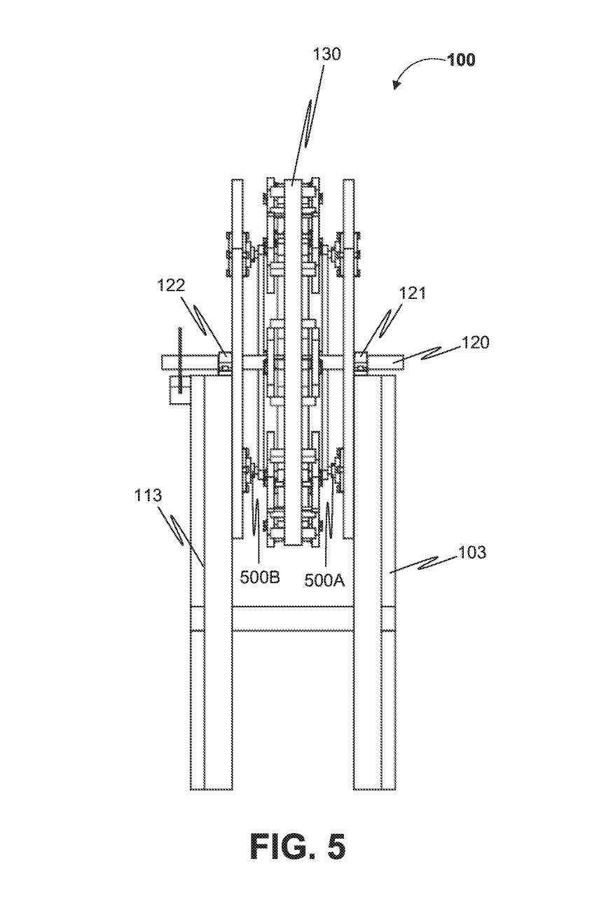

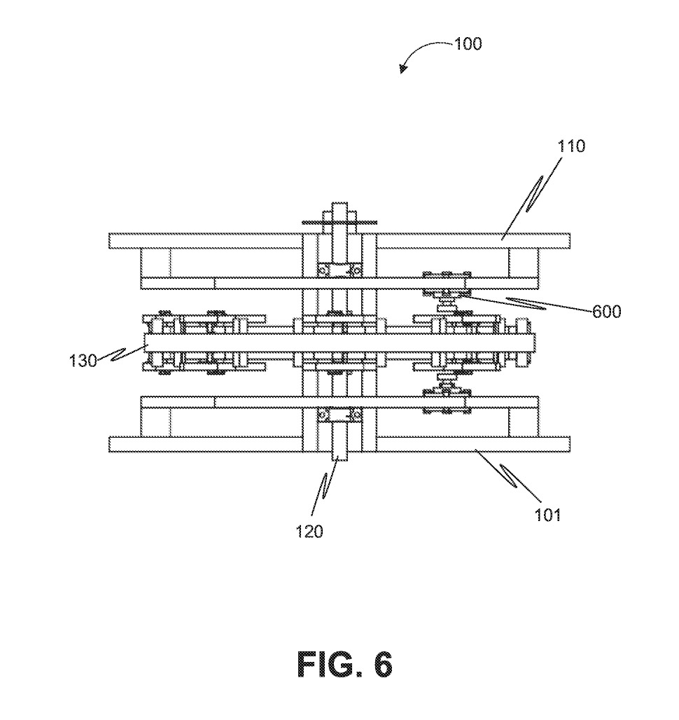

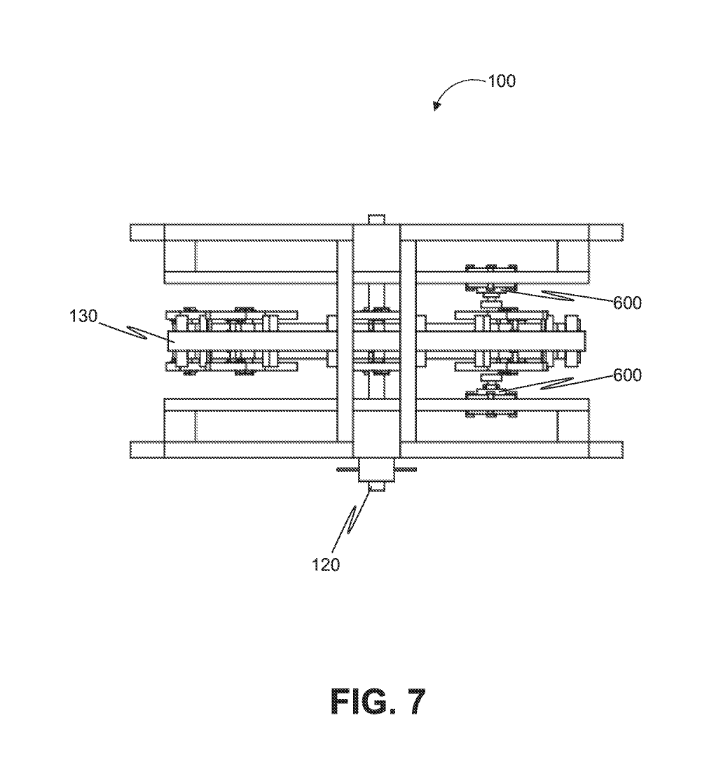

All illustrations of the drawings are for the purpose of describing selected versions of the present invention and are not intended to limit the scope of the present invention. In this regard, it should be noted that the drawings, particularly FIGS. 1 through 13, may not show all of the components of the present invention to the scales or in the shapes that may be utilized in physically constructing the present invention. Further, the present invention, or otherwise referred to as the “gravity motor”, is described in a preferred embodiment and an alternative embodiment. The preferred embodiment and the alternative embodiment of the gravity motor differ in configuration of weights and the movement of the weights to create rotational torque. Both embodiments of the present invention relate to rotational machines and utilize the principle of converting gravitational potential energy into rotational kinetic energy.

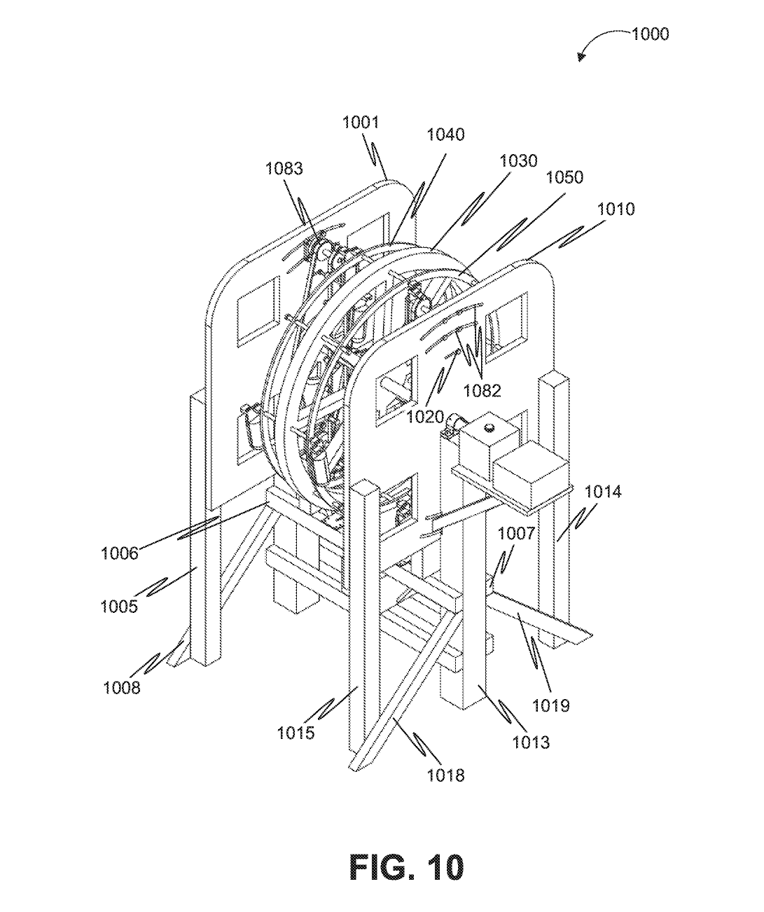

The gravity motor is configured to provide rotational torque to an electric generator or other work machine, such as an alternator, pump, wheel or the like, through a primary axle (i.e., an output shaft), which is operatively connected to the electric generator. The electrical output of the electric generator can be used to operate a variety of electrical devices or other power generations means such as electromagnets or an electrolytic cell for a hydrogen motor or fuel cell. The gravity motor is supported on a platform, a base, level ground, or other flat surface by a frame structure comprising frame plates, vertical frame posts, and horizontal and diagonal braces. Specifically, a preferred embodiment of the gravity motor 100 is shown in FIGS. 1 through 9, wherein two spaced frame plates—a first frame plate 101 and a second frame plate 110—lie in a vertical plane, each supported on the outward-facing surface thereof by a plurality of vertical frame posts. In the alternative embodiment of the gravity motor 1000 shown in FIGS. 10 thorough 13, two spaced frame plates—a first frame plate 1001 and a second frame plate 1010—lie in a vertical plane, each supported on the outward-facing surface thereof by a plurality of vertical frame posts. The frame plates may be cut to any shape and may have excess material cutout therefrom to be recycled and to provide visibility for operators. The preferred embodiment of the gravity motor 100 shown in FIGS. 1 through 9 comprise a plurality of vertical frame posts for each frame plate. The vertical frame posts corresponding to frame plates 101 & 110 include center posts 103, 113 and side posts 104, 105, 114, 115 wherein the side posts 104 & 105 are symmetrically spaced about the center post 103 and side posts 114 & 115 are symmetrically spaced about the center post 113. At least one pair of horizontal frame post braces 106 and 107 connect the center post of each plate together to increase structure stability and to support other components of the gravity motor, as will be described hereinafter. The frame post braces are affixed oppositely on the center posts and are levelly positioned below the frame plates. Diagonal braces 108, 109, 118, 119 connecting the center posts and the side posts together are provided for further structural stability. The alternative embodiment shown in FIGS. 10 through 13 comprise a plurality of vertical frame posts for each frame plate. The vertical frame posts corresponding to frame plates 1001 & 1010 include center posts 1003, 1013 and side posts 1004, 1005, 1014, 1015 wherein the side posts 1004 & 1005 are symmetrically spaced about the center post 1003 and side posts 1014 & 1015 are symmetrically spaced about the center post 1013. At least one pair of horizontal frame post braces 1006 and 1007 connect the center post of each plate together to increase structure stability and to support other components of the gravity motor, as will be described hereinafter. The frame post braces are affixed oppositely on the center posts and are levelly positioned below the frame plates. Diagonal braces 1008, 1009, 1018, 1019 connecting the center posts and the side posts together are provided for further structural stability.

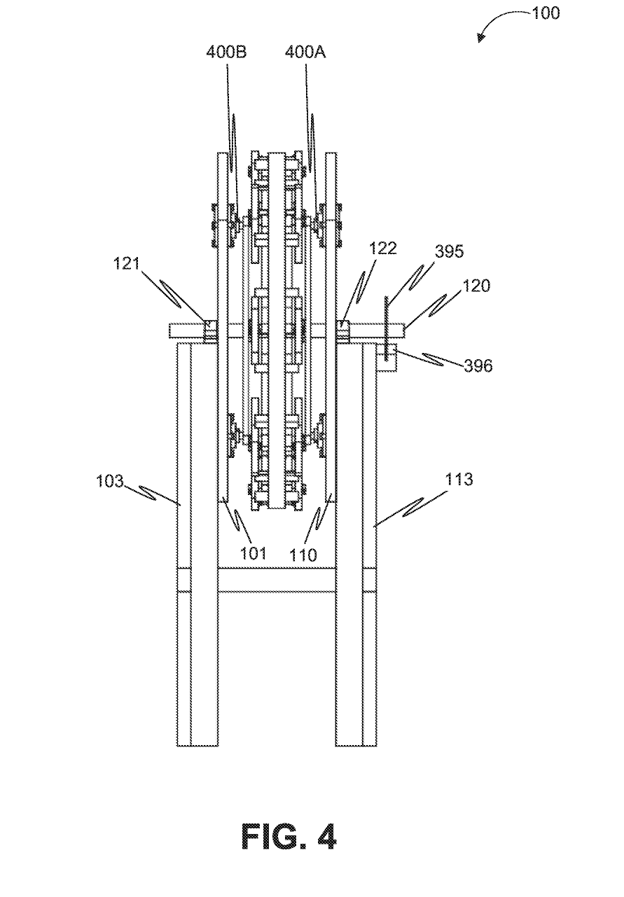

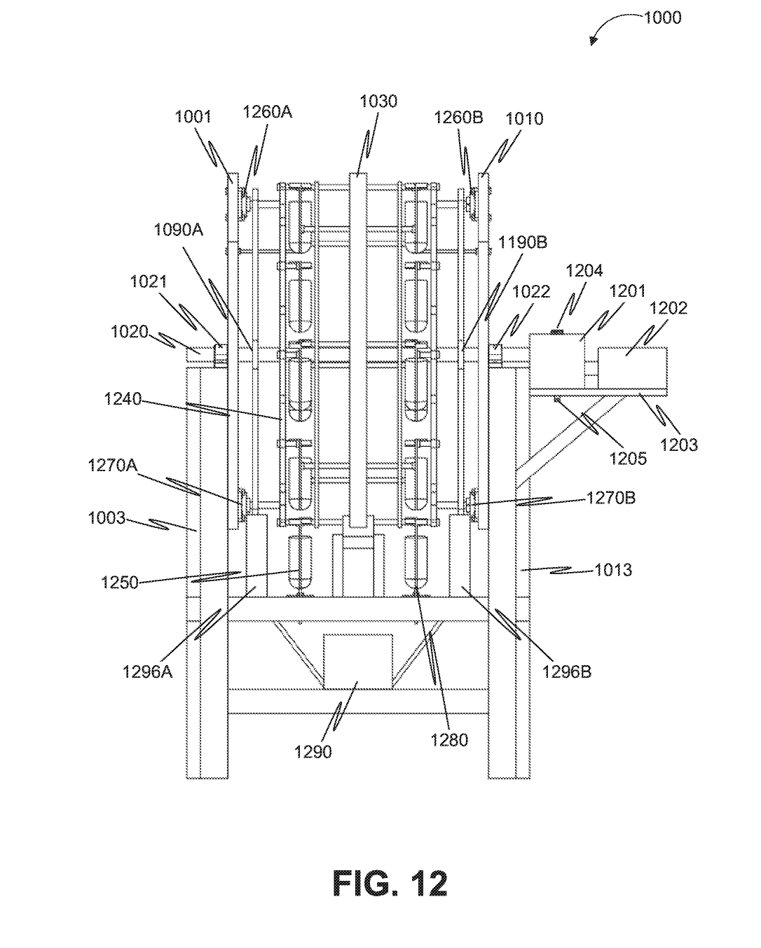

With reference to FIG. 4, the two center posts 103, 113 of the frame structure support a primary axle 120 which is used as the output shaft of the gravity motor. Each center post has on its top end a pillow block containing a suitable low-friction bearing such a ball bearing, roller bearing (cylindrical, spherical, tapered, etc.), fluid bearing, or electromagnetic bearing. The primary axle is horizontally oriented and rotatably supported across the center posts at its ends by the pillow block mounted bearings 121, 122 where the primary axle 120 traverses through the first pillow block 121, the first frame plate 101, the second frame plate 110, and the second pillow block 122. The pillow block mounts can be replaced with flange mounts. Alternate configurations of the preferred embodiment of the gravity motor may include more than one primary axle. With reference to the alternate embodiment of the gravity motor in FIG. 12, the primary axle 1020, and pillow blocks 1021, 1022 are depicted. Additionally, the pillow block mounts are not limited to just the primary axle and can be used where appropriate. As the gravity motor operates, the primary axle produces the rotational torque that is used to drive the electric generator or other work machine. The primary axle and electric generator are interfaced by a transmission, which transmits the torque from the primary axle of the gravity motor to the generator. In the alternative embodiment as depicted in FIG. 12, transmission 1201 and electric generator 1202 are supported on top of a platform 1203 connected adjacent to one of the center posts 1013. Additionally, the transmission is contained within a sealed but accessible housing that allows the changing of lubrication fluids via a screw cap 1204 on the top of the housing and a drain plug 1205 on the bottom of the housing. It does not matter to which end of the primary axle the transmission and electric generator are connected, so the platform may be connected adjacent to either center post. If desired, however, the primary axle can be sufficiently long so that the electric generator can be physically separate from the gravity motor. The general structure of the frame structure is the same for both main embodiments of the gravity motor.

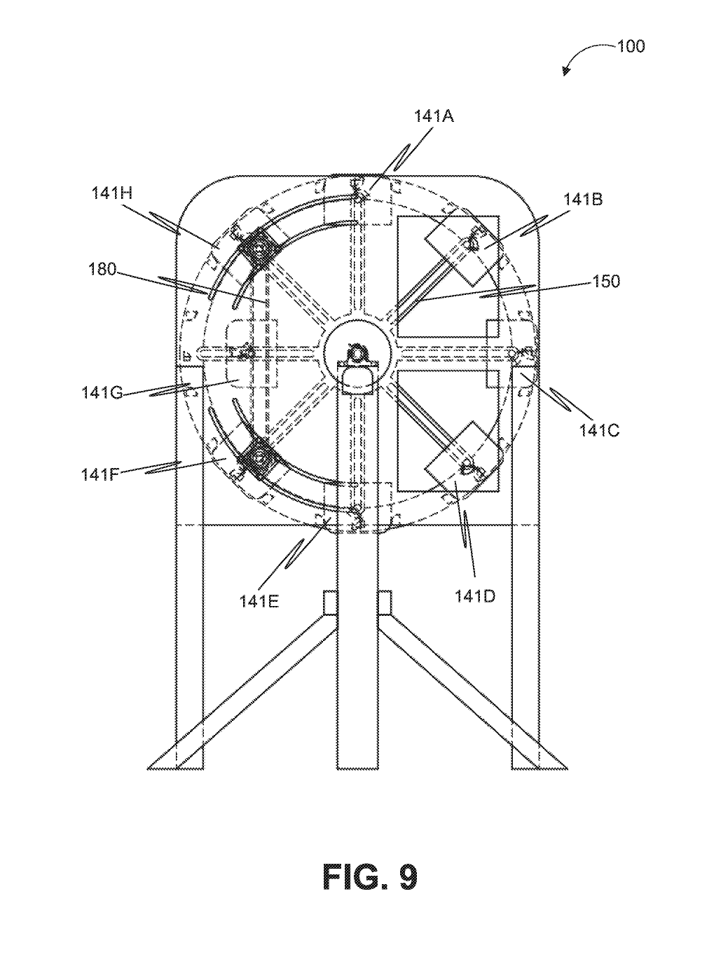

The preferred embodiment of the gravity motor 100 is depicted in FIGS. 1 through 9. In the preferred embodiment, the gravity motor 100 utilizes a leverage arm wheel to slide weights to and from the edge of the primary load wheel in order to create rotational torque. With reference to FIGS. 1 through 9, concentrically coupled to the primary axle 121 are a primary load wheel 130, a first leverage arm wheel 140, and a second leverage arm wheel 150. The leverage arm wheels comprise arms with slots extending from a central location to allow the weights to slide along the primary load wheel 130, as depicted in FIG. 9. The leverage arm wheel may also accept and comprise of additional slotted material to allow the weights to slide along, where the additional slotted material carries the weights and is attached with rollers to the leverage arm wheel's slots depending on orientation implemented into the design (not shown in figures). The primary load wheel 130 is medially positioned on the primary axle 121 and is thus positioned equidistantly from both frame plates 101 and 110. The first leverage arm wheel 140 is positioned on the primary axle 121 between the primary load wheel 130 and the first frame plate 101. The second leverage arm wheel 150 is positioned on the primary axle 121 between the primary load wheel 130 and the second frame plate 110. The first and second leverage arm wheels are fastened to the primary load wheel and will rotate synchronously. In other words, the primary axle 121, primary load wheel 130, and both leverage arm wheels 140,150 are locked together in order to rotate in a vertical plane as a single unit. The primary load wheel and leverage arm wheels may be secured to the primary axle by way of collars (not shown in figures). Collars may comprise of clamps, set screws, splits, and other such fastening elements. In an alternative embodiment, the leverage arm wheel may be integrated into the primary load wheel, instead of being a separate attached component. Meaning, the primary load wheel can further comprise slots that may also accept or comprise of additional slotted material attached by rollers to the primary slots depending on orientation implemented into the design (not shown in figures) for accepting sliding weights. Alternate configurations of the preferred embodiment of the gravity motor may include more than one primary load wheel.

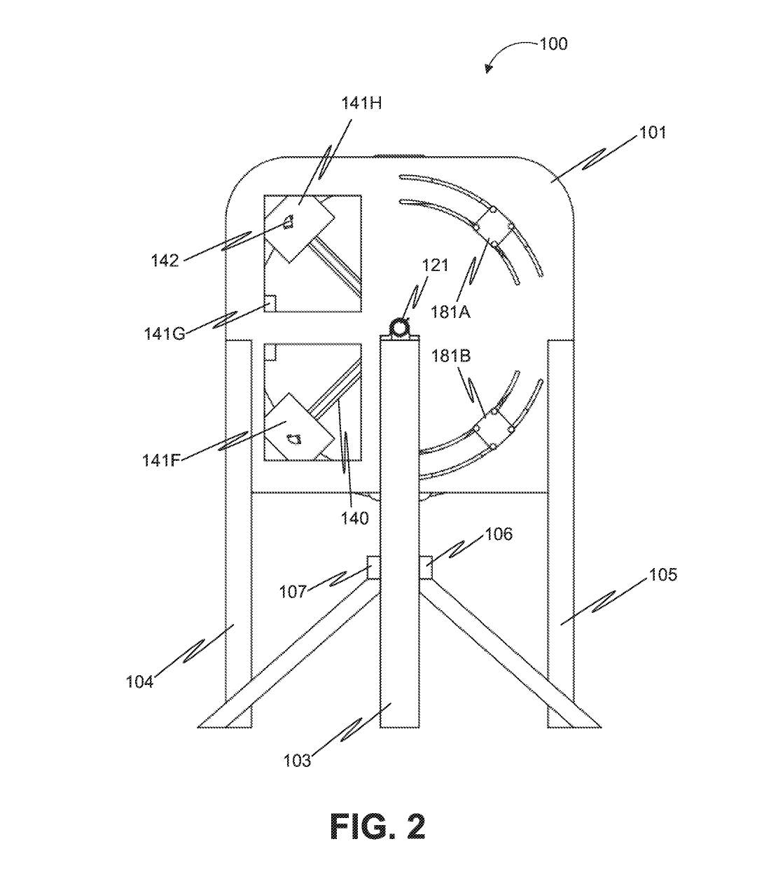

With reference to FIGS. 2, 4, 5, 6, 7 & 9, the movement of the weights along the leverage arm wheel slots is used to drive transfer sprockets via a drive member such as a drive chain or belt. At least one weight is hooked to a drive chain, or otherwise referred to as the weight attachment chain, at any given time during the operation of the gravity motor. Alternatively, a plurality of drive members may be used to guide the orientation of the chain in setting up the weight's path as the weight is attached to the drive chain which in turn drive the transfer sprockets. Hooks encompass the outer surface of the weight attachment chain to allow weights to be attached as they move guided along the slots of the leverage arm wheel. Each side of the primary load wheel 130 has associated therewith an upper transfer sprocket 400 and lower transfer sprocket 500, where each of the transfer sprockets is fixed to a transfer sprocket axle. The upper and lower transfer sprockets are arranged equidistantly above and below the primary axle 121, but offset horizontally to one side of the frame plate. A weight attachment chain 180 is affixed to the upper transfer sprocket 400 and lower transfer sprocket 500, allowing for rotational movement. In total, there are four transfer sprockets 400A, 400B, 500A & 500B and correspondingly four transfer sprocket axles. Each transfer sprocket axle is rotatably mounted at one end to one frame plate via a flange mounted bearing 600. The transfer sprocket axles extend from the frame plates toward the primary load wheel in parallel relationship with the primary axle. Each transfer sprocket axle may be the same size as all the other transfer sprocket axles in some embodiments. However, in an alternate configuration of transfer sprocket axles, each transfer sprocket axle may be of a size dissimilar to other transfer sprocket axles. Similar to the pillow block mounted bearings for the primary axle, each flange mounted bearing is a suitable low-friction bearing such a ball bearing, roller bearing (cylindrical, spherical, tapered, etc.), fluid bearing, or electromagnetic bearing. Flange mounts 181A, 181B, 181C &181D are attached to the frame plates via bolts that traverse through pairs of arcuate slots 182 formed in the frame plates. The arcuate slots 182 allow the flange mounts for the transfer sprocket axles to be positionable along the frame plates. When loosened, the bolts slidingly engage the arcuate slots. When the flange mounts are in the desired positions, the bolts can be manually tightened with washers and nuts to secure the flange mounts in place. An additional set of flange mounts are fastened to the opposite side of the frame plates. A bar connects the outside flange mounts together and mounted to the frame to help further stabilize the transfer axles and help maintain the operational conditions of the bearings. Additionally, the arcuate slots may comprise degree measurements labeled or marked on the frame plate for the operator to easily identify the angular location of the flange mounts.

With reference to FIGS. 1, 2 and 3, each pair of arcuate slots 182 is specifically formed as arc segments of a pair of two different-sized circles whose centers lie on the longitudinal axis of the primary axle. In this manner, the flange mounted bearings can locate the transfer sprocket axles to accept weight attachment chains of varying lengths or at angled positions while maintaining a constant radius from the primary axle. Lengthening or shortening the weight attachment chain 180 directly correlates to its horizontal distance to the primary axle 121, and thus the circumferential length of the resistance zone. The resistance zone refers to the circumferential length in which the weights are moved toward the primary axle, providing less resistance, therefore allowing the primary load wheel to rotate due to the offset weights.

The weight attachment chains are used to hook weights sliding along the leverage arm wheel. The weight attachment chains are arranged between the leverage arm wheels and the frame plates. The weights are hooked to and from the primary load wheel and weight attachment chain as they rotate with the primary load wheel. Through action of gravity, the weights along with their position and overall relation to the primary axle provide the driving force that unbalances the primary load wheel, thus causing the primary load wheel to rotate (clockwise in FIG. 9) and generate torque about the primary axle. To this end, both weight attachment chains 180 and the primary load wheel 121 include a plurality hooks (not seen in figures) to which a plurality of sliding weights 141 attach. The primary load wheel 130 further comprises a plurality of guide stops in which prevents the weights from detaching from the primary load wheel hooks and guides the weights into said hooks. The curvature of the upper end of the weights, guide stops, hooks and handles aid in rotating the weights upon contact to engage and disengage them from the hooks.

With reference to FIG. 9, the weights 141A, 141B, 141C, 141D, 141E, 141F, 141G, 141H, are rotatably affixed to the leverage arm wheel slots. One weight is arranged to each leverage arm slot. Eight weights are rotatably affixed to each leverage arm wheel, totaling sixteen weights 141 for the gravity motor 100. The weights are solid, plate-type components that comprise bearing mounted arms and handles which engage with the hooks of the primary load wheel 130 and weight attachment chain 180. Each weight comprises a plurality of handles configured to engage with the plurality of hooks of each of the at least one primary load wheel and each weight attachment unit. A first handle of the plurality of handles (not seen in figures) is affixed to the surface of the weight facing parallel to the primary load wheel and a second handle 142 of the plurality of handles is affixed to the opposing surface. The first handle is configured to engage the primary load wheel hooks and the second handle 142 is configured to engage the weight attachment hooks. The handles may be constructed in a variety of ways, but generally comprise curved slot portions, wherein contacting the hooks causes the weights to rotate for proper engagement and disengagement.

In operation, the leverage made by the position and overall relation of the weights 141 to the primary axle 120 rotate the primary load wheel 130, which then allow the weights to disengage and engage upon contact to rotate the transfer sprockets 400A, 400B, 500A, 500B, which finally moves the weight attachment chain 180. The weights engage and disengage from the weight attachment chain 180 at the lower and higher ends of the resistance zone, respectively. In essence, the weight attachment chain 180 pulls the weight 141 toward the center of the primary load wheel, providing less resistance and leverage on the side corresponding to the weight attachment chain 180. This allows the primary load wheel 130 to continually rotate in the clockwise direction. More specifically, each weight, rotatably affixed to the leverage arm wheel and thus the primary load wheel by hooks, provides the torque for actuating the system.

There are many variable factors that need to be taken into consideration in order to accurately and precisely time and position the weights to properly engage and disengage from the primary load wheel and weight attachment chain as well as affect the overall performance of the gravity motor. These include but are not limited to:

The radii of the transfer sprockets;
The location of the flange mounts and thus the transfer sprockets;
The location of the hooks on the primary load wheel;
The location of the hooks on the weight attachment chain;
The location and angle in which the handles are affixed to the weights;
The curvature of the weights;
The curvature of the hooks and handles;
The distance between the longitudinal axes of the primary axle and transfer sprocket axles;
The length of the weight attachment chains;
The number of weights used;
The size of the weights used;
The mass and center of gravity of each weight; and
Types of bearings and other rotational connections used.

In the alternative embodiment, the gravity motor utilizes a series of drive sprockets and drive chains to load and unload weights from the primary load wheel to create leverage for rotation. In this embodiment, the weights will be transferred from the weight attachment chain to the primary load wheel and vice versa. With reference to FIGS. 10 through 13, concentrically coupled to the primary axle 1020 are a primary load wheel 1030 and drive sprockets 1190 comprising a first drive sprocket 1190A, and a second drive sprocket 1190B. The primary load wheel 1030 is medially positioned on the primary axle 1020 and is thus positioned equidistantly from both frame plates. The first drive sprocket 1190A is positioned on the primary axle 1020 between the primary load wheel 1030 and the first frame plate 1001. The second drive sprocket 1190B is positioned on the primary axle 1020 between the primary load wheel 1030 and the second frame plate 1010. The drive sprockets are equidistant from the primary load wheel. The drive sprockets 1190 may be positioned closer to the frame plates than they are to the primary load wheel in some embodiments. However in alternative configurations, the drive sprockets 1190 may be positioned closer to the primary load wheel than they are to the frame plates. The primary load wheel 1030 and both drive sprockets 1190A & 1190B are coupled to the primary axle 1020 via key and keyway connections and secured to the primary axle by way of collars (not shown in figures). Collars may comprise of clamps, set screws, splits, and other such fastening elements. As a result, the primary axle, primary load wheel, and both drive sprockets are locked together in order to rotate in a vertical plane as a single unit. The primary load wheel and both drive sprockets are preferably constructed as spoked wheels in order to reduce mass and thus reduce moment of inertia.

With reference to FIGS. 10 through 13, each drive sprocket 1190 is used to drive sets of transfer sprockets 1260 & 1270 via a drive chain or belt. Each drive sprocket 1190 has associated therewith two sets of transfer sprockets, where each set of transfer sprockets is fixed to a transfer sprocket axle via key and keyway connections. In total, there are four sets of transfer sprockets and four transfer sprocket axles. For each drive sprocket, one associated set of transfer sprockets 1260A, 1260B is positioned above the drive sprocket (i.e., an upper set) and the other associated set of transfer sprockets 1270A & 1270B is positioned below the drive sprocket (i.e., a lower set), where the upper and lower sets of transfer sprockets are equidistant from the primary axle.

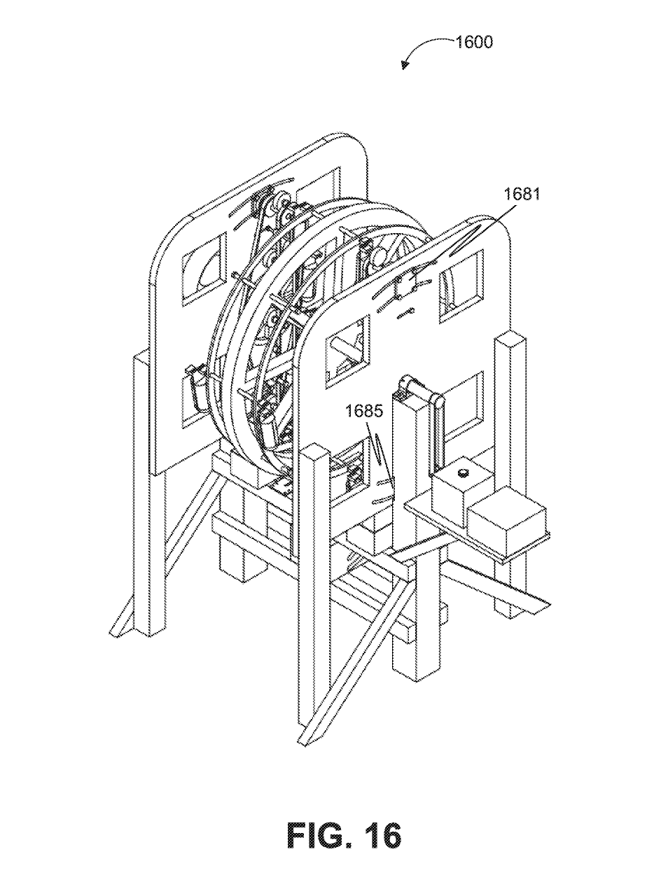

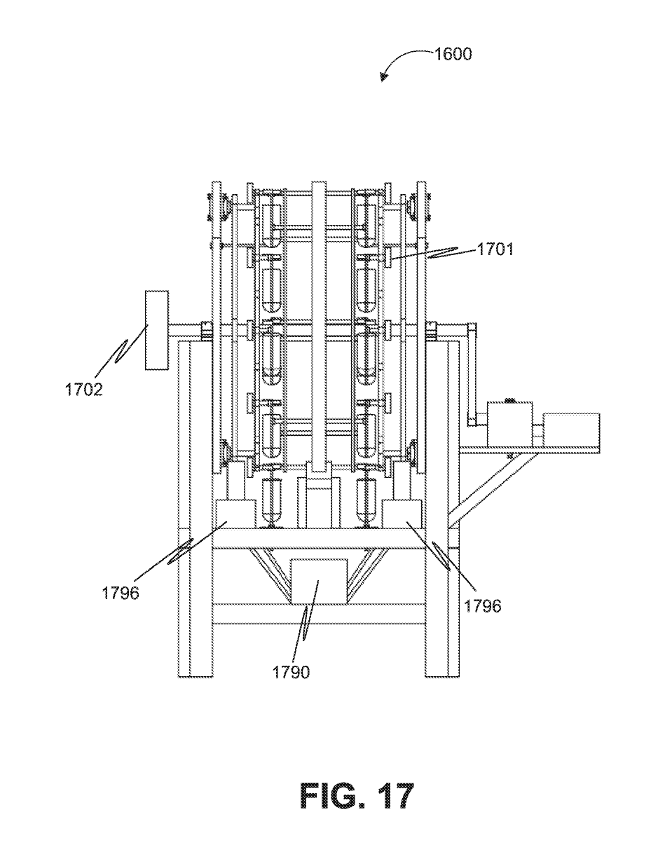

Each transfer sprocket axle is rotatably mounted at one end to one frame plate via a flange mounted bearing 1083 as depicted in FIG. 10. The transfer sprocket axles extend from the frame plates toward the primary load wheel in parallel relationship with the primary axle. In some embodiments, each transfer sprocket axle may be the same size as all the other transfer sprocket axles. However, in an alternate configuration of transfer sprocket axles, each transfer sprocket axle may be of a size dissimilar to other transfer sprocket axles. Similar to the pillow block mounted bearings for the primary axle, each flange mounted bearing is a suitable low-friction bearing such a ball bearing, roller bearing (cylindrical, spherical, tapered, etc.), fluid bearing, or electromagnetic bearing. The flange mounts are attached to the frame plates via bolts that traverse through pairs of arcuate slots 1082 formed in the frame plates. The arcuate slots 1082 allow the flange mounts for the transfer sprocket axles to be positionable along the frame plates. When loosened, the bolts slidingly engage the arcuate slots. When the flange mounts are in the desired positions, the bolts can be manually tightened with washers and nuts to secure the flange mounts in place. An additional set of flange mounts can be fastened to the opposite side of the frame plates. A bar connects the outside flange mounts together and mounted to the frame to help further stabilize the transfer axles and help maintain the operational conditions of the bearings. The addition of the flange mount brackets 1681 are depicted in FIG. 16 and FIG. 17.

With reference to FIGS. 10, 11 and 13, each pair of arcuate slots is specifically formed as arc segments of a pair of two different-sized circles whose centers lie on the longitudinal axis of the primary axle. In this manner, the flange mounted bearings can locate the transfer sprocket axles directly above and below the primary axle or at angled positions while maintaining a constant radius from the primary axle. Because the flange mount bolts traverse through the frame plates and because the center posts of the frame structure abut against the outward-facing surfaces of the frame plates, the center posts each have an edge slot 1685 cut therein where the arcuate slots for the lower sets are positioned. These edge slots 1685 provide clearance which allows the flange mount bolts to pass by the center posts as depicted in FIG. 16.

With reference to FIGS. 10 through 13, each set of transfer sprockets includes a first transfer sprocket and a second transfer sprocket. For each set of transfer sprockets, the first transfer sprocket is fixed to the transfer sprocket axle in alignment with the associated drive sprocket. As stated above, the drive sprockets drive the sets of transfer sprockets via drive chains or belts. Specifically, a drive chain 1186 is provided for each drive sprocket 1090, wherein the drive chain 1186 passes over the drive sprocket 1190A, the first transfer sprockets 1260A of the associated upper set, and the first transfer sprocket 1270A of the associated lower set in meshed engagement. As the primary axle 1020 rotates, the drive sprockets move the drive chains 1186, which rotate the first transfer sprockets of the upper and lower sets. The second transfer sprocket of each set is fixed to the end of the transfer sprocket axle opposite the flange mounted bearing. For each drive sprocket, because each transfer axle is the same length, the second transfer sprocket of the associated upper set is in alignment with the second transfer sprocket of the associated lower set.

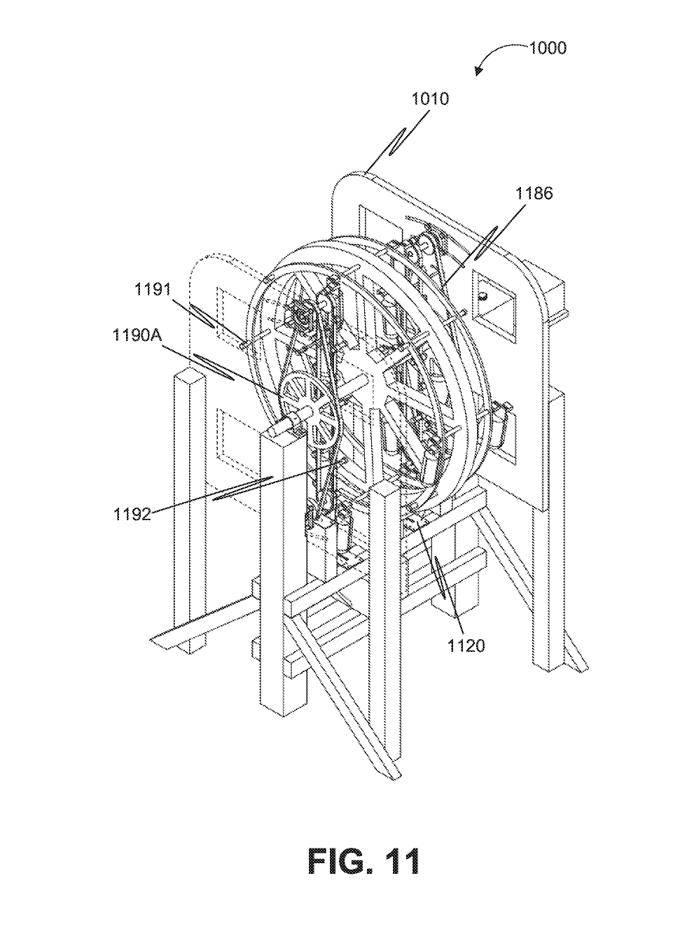

With reference to FIGS. 11 through 13, the second transfer sprockets are used to drive other belts or chains herein referred to as a weight attachment chains. Specifically, for each drive sprocket, the weight attachment chain 1240 is connected in meshed engagement with the second transfer sprocket 1260A of the associated upper set and the second transfer sprocket 1270A of the associated lower set. The weight attachment chains pass around the primary axle. Because of this, the second transfer sprockets are larger in diameter than the primary axle so that sufficient clearance is maintained between the weight attachment chains and the primary axle.

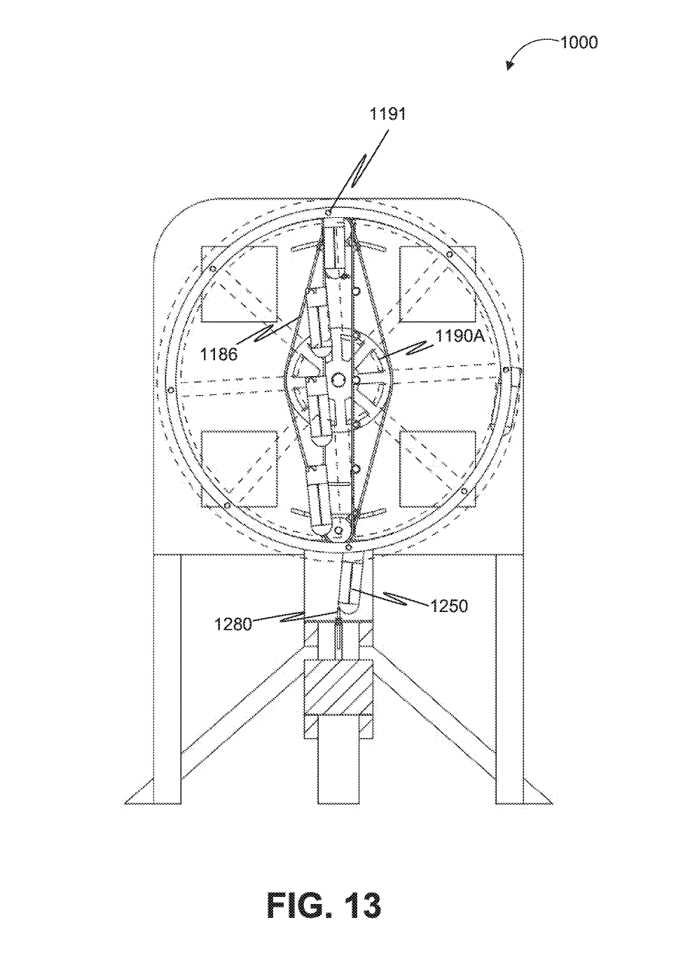

The weight attachment chains are used to carry a plurality of suspended weights 1250. The weights 1250 are transferred between the weight attachment chains 1240 and the primary load wheel 1030. Through action of gravity, the weight's position and relation to the primary axle provide the driving force that unbalances the primary load wheel, thus causing the primary load wheel to rotate (clockwise in FIG. 13) and generate torque about the primary axle. To this end, both weight attachment chains and the primary load wheel include a plurality of transfer pegs to which the plurality of suspended weights attach.

The transfer pegs are preferably constructed as cylindrical dowels with enlarged heads at the free ends that project from the weight attachment chains and the primary load wheel. As can be best seen in FIGS. 11 and 12, the weight attachment chain transfer pegs 1192 project toward the primary load wheel 1030 parallel to the primary axle 1020. The primary load wheel has transfer pegs on both sides, wherein the primary load wheel transfer pegs 1191 project toward weight attachment chains parallel to the primary axle. As can be best seen in FIG. 13, the primary load wheel transfer pegs 1191 are positioned adjacent the circumferential edge of the primary load wheel and are arranged in an evenly spaced circular pattern about the primary axle. In the embodiment shown in FIGS. 10 through 13, eight transfer pegs 1191 project from each side of the primary load wheel 1030, all the same radial distance from the primary axle 1020 and each separated from the adjacent transfer pegs by 45 degrees as depicted. Weight attachment chain transfer pegs 1192 are evenly spaced along the length of the weight attachment chains.

The weights, which may be either solid or liquid, are suspended from hooks. If solid weights are used, each weight may be divided into smaller plates or blocks that can be added or removed as desired to adjust the total mass of each weight. In configuration of the alternative embodiment, the weights may be in the form of weight rods. These rods are mounted through slots of two primary wheels each on opposite ends and connected to transfer plates on the opposing sides of the primary wheels where these transfer plates have the associated hooks or handles to accompany itself to the primary wheels and the weight attachment chains. If liquid weights are used, the weights are configured as containers to which liquid can be added or from which liquid can be drained as desired to adjust the total mass of each weight. The hooks may be constructed in a variety of ways, but generally comprise oppositely oriented first and second hooking portions, wherein the first hooking portion engages weight attachment chain transfer pegs and the second hooking portion engages primary load wheel transfer pegs.

In operation, the weights 1250 rotate primary load wheel 1030, which rotates the primary axle 1020, which rotates the drive sprockets 1190, which then move the drive chains 1186 to rotate the sets of transfer sprockets 1260 & 1270, which finally move the weight attachment chains 1240. The transfer pegs are precisely spaced so that the primary load wheel transfer pegs meet the weight attachment chain transfer pegs at the apex or top-dead-center (TDC) point of the top transfer sprockets and at the bottom or bottom-dead-center (BDC) point of the bottom transfer sprockets. When the transfer pegs of the primary load wheel and weight attachment chains meet at these positions, transfer points are created at which the weights are exchanged between the weight attachment chains and the primary load wheel. Weights are transferred onto the primary load wheel from the weight attachment chains at the TDC point. Weights are transferred back onto the weight attachment chains from the primary load wheel at the BDC point. For every weight that is transferred onto the load wheel at the TDC point, a weight is simultaneously transferred back onto a weight attachment chain at the BDC point, thus continually unbalancing the primary load wheel and driving the rotation thereof.

More specifically, each weight, carried on one of the weight attachment chain transfer pegs by the first hook portion, is lifted upward by the weight attachment chain. As the weight crests the second transfer sprocket 1260A, 1260B on the upper set of transfer sprockets, a primary load wheel transfer peg 1191 approaches the weight from behind and moves into the second hook portion. The weight attachment chain transfer peg moves downward after cresting the second transfer sprocket of the upper set, dropping the weight onto the primary load wheel transfer peg 1191. This functionality depends on the degree in which the flange mounts are arranged, and thus the timing of the gravity motor. For example, if the timing is advanced at TDC, meaning the weight is coming off the weight attachment chain earlier, the primary wheel would lift the weight off the attachment chain as opposed to the attachment chain dropping the weight onto the primary wheel. The weight travels along the outside of the primary load wheel, the hook keeping the weight in a vertical orientation as it hangs from the primary load wheel transfer peg. As the weight approaches the bottom of the primary load wheel, a weight attachment chain transfer peg 1192 moves around the second transfer sprocket on the lower set of transfer sprockets. As the weight attachment chain transfer peg 1192 begins to travel upward again, it moves into the first hook portion and lifts the weight off the primary load wheel transfer peg and back onto the weight attachment chain. Counterweights can be attached to the opposite side of the weight attachment chain as shown by the disk shaped components 1701 attached on the opposing side of the weight transfer peg in FIG. 17. The weight of the counterweights are equal to the weights on the opposing side of the weight attachment chain. The counterweights 1701 can be made to be a variety of shapes and sizes as long as it does not impede the motion of the gravity motor in any way and weighs the same amount as the weights. The counterweights balance the load acting on the weight attachment chain from the weights. The counterweights are not added for the purpose of affecting the output of the gravity motor, but to simply help balance the chain from being too heavy on the side that the active weights are attached to. This will alleviate the unbalanced flex or pressure on the weight attachment chain, making it more stable and equalizing the pressure acting on the sprocket.

There are many variable factors that need to be taken into consideration in order to accurately and precisely time and position the weight transfers as well as affect the overall performance of the gravity motor. These include but are not limited to:

The radii of the drive sprockets;
The radii of the transfer sprockets;
The radial distance of the primary load wheel transfer pegs from the longitudinal axis of the primary axle;
The ratios between the drive sprocket radii, transfer sprockets radii, and primary load wheel transfer peg radius;
The number of transfer pegs on the primary load wheel;
The angle from the center primary axle between each of the primary load wheel transfer pegs;
The arc length between each of the primary load wheel transfer pegs;
The distance between the longitudinal axes of the primary axle and transfer sprocket axles;
The length of the weight attachment chains;
The distance between transfer pegs along the length of the weight attachment chains;
The number of weights used;
The size of the weights used;
The mass and center of gravity of each weight;
Types of bearings and other rotational connections used; and
Gearing ratios in the transmission.

Some of the above factors are dependent on other factors. For example, the primary load wheel transfer pegs travel at a different absolute speed than the weight attachment chain transfer pegs due to the different radii and angular velocities of the primary load wheel and transfer sprocket axles. The arc lengths between the primary load wheel transfer pegs and distances between the weight attachment chain transfer pegs will depend on these radii and angular velocities to ensure that the transfer pegs meet at the aforementioned transfer points.

The gravity motor has additional components that may help increase performance, increase longevity of mechanical parts, reduce maintenance, reduce noise and increase safety during operation. The additional components mentioned hereafter may be applied to either the preferred or alternative embodiment of the gravity motor, but will mainly be discussed in relation to the alternative embodiment. With reference to FIGS. 11 through 13, a stabilizer ring may be connected to the primary load wheel transfer pegs on each side of the primary load wheel of the alternative embodiment. Because the primary load wheel transfer pegs 1191 are mounted to the primary load wheel in a cantilever fashion, they may be subjected to flexural vibrations while carrying the plurality of weights. The purpose of the stabilizer rings is to reduce flexure in the primary load wheel transfer pegs and absorb vibrations. The stabilizer rings are positioned between the primary load wheel and the enlarged heads of the primary load wheel transfer pegs.

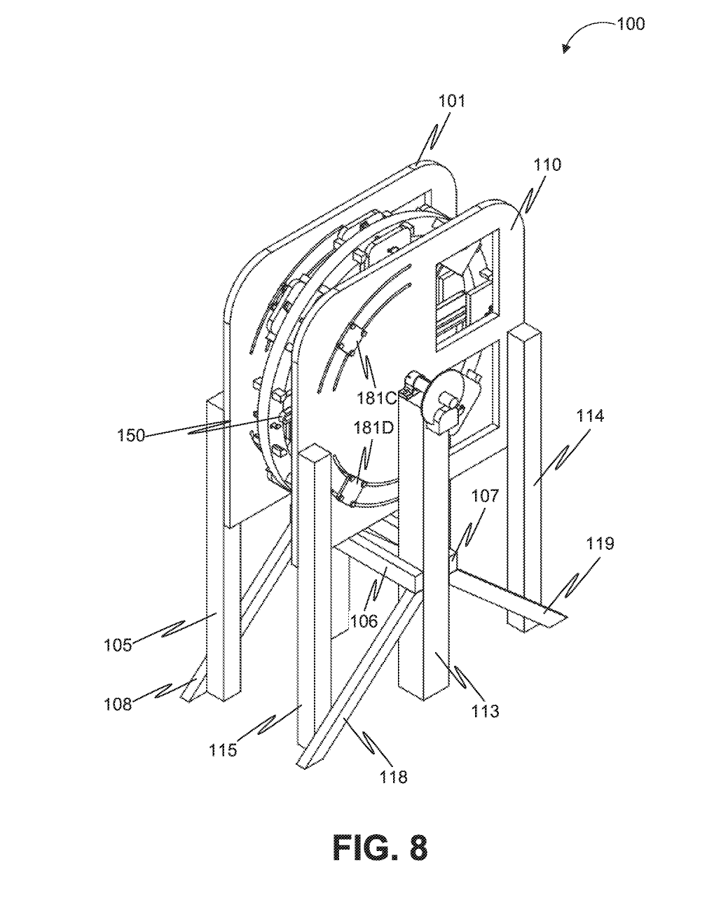

With reference to FIG. 12, brake calipers are mounted to the horizontal frame posts braces underneath the primary load wheel of the alternative embodiment. The brake calipers are configured in a known manner, where the calipers are operated by a lever to selectively engage the primary load wheel to stop its rotation for maintenance and repairs or to hold in place while the gravity motor is being set up for operation. The brake lever or levers may be mounted anywhere on the frame structure or they may be located at a physically separate location. The brake calipers can be mounted to any other part of the frame structure provided that they can be safely supported to the primary load wheel. For example, FIG. 8 depicts a brake system comprising a disc 395 and brake caliper 396 incorporated into the preferred embodiment of the gravity motor. This brake system is affixed to the primary axle, rather than directly to the primary load wheel. Furthermore, any number of brake calipers may be used. Additionally, a jam rod (not shown in figures) is used to jam the gravity motor during repairs or maintenance. The jam rod is preferably electro mechanically actuated and may be located on a frame plate or any other part such that the jam rod does not interfere with the regular functioning of the gravity motor. In an ideal situation, brakes are applied to stop the gravity motor and the jam rod is actuated after application of brakes.

With reference to FIGS. 11 through 13, weight stops may optionally be provided on the frame structure to angle the weight hooks for receiving the transfer pegs on the primary load wheel and weight attachment chains. Two lower weight stops 1280 are mounted to the horizontal frame post braces below the primary load wheel 1030. The lower weight stops 1280 are configured as threaded bolts attached to weight stop plates. The lower weight stops 1280 traverse through slots in the weight stop plates 1120 and are secured thereto with washers and nuts on each side of the weight stop plates. When the washers and nuts are loosened, the lower weight stops 1280 can be horizontally adjusted along the length of the slot and can be adjusted vertically by rotating the lower weight stop clockwise or counterclockwise. In operation, the weights strike the lower weight stops when they reach the BDC transfer point, causing the weight to tilt as the hook keeps moving with the primary load wheel transfer peg. This angles the weight hook to receive the weight attachment chain transfer peg. Each frame plate has an upper weight stop 1020 mounted thereto for angling the weight hooks for receiving primary load wheel transfer pegs at the TDC transfer point. The upper weight stops are configured as horizontally extending threaded bolts. Like the flange mounted bearings, the upper weight stops 1020 traverse through arcuate slots formed in the frame plates so that they can be located at degreed positions at a constant radius from the primary axle. The upper weight stops 1020 are secured in the arcuate slots by washers and nuts on each side of the frame plate. The upper weight stops 1020 are adjusted by loosening the washers and nuts.

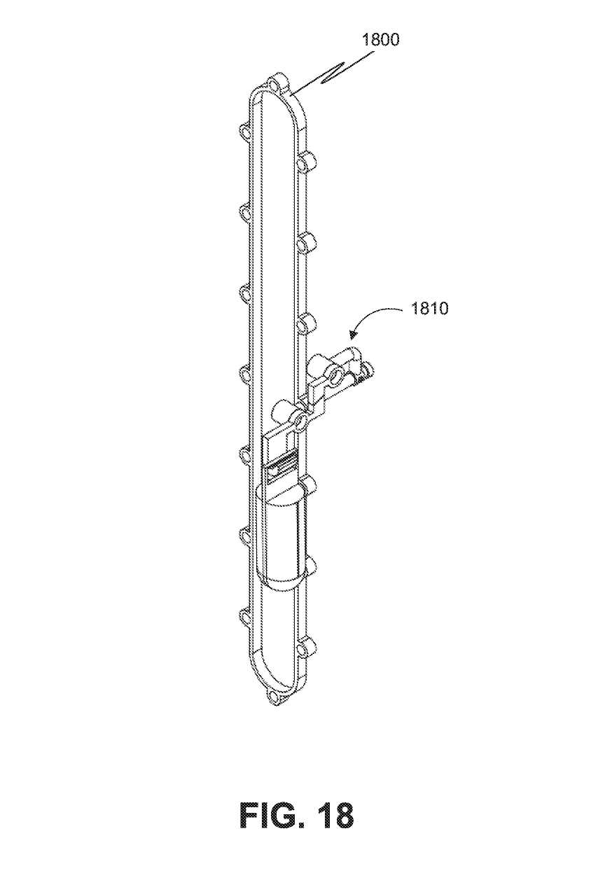

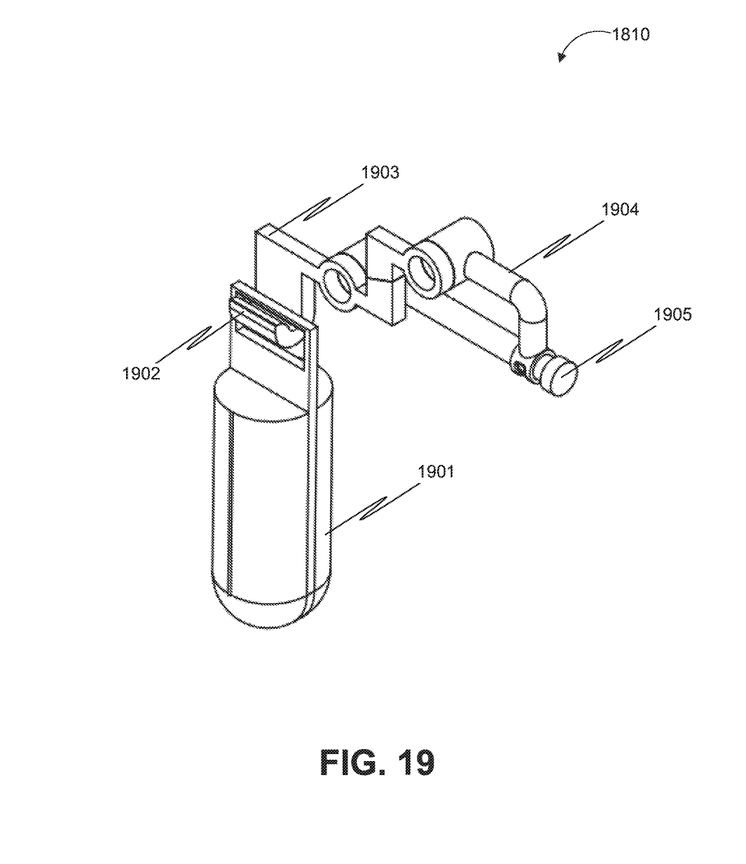

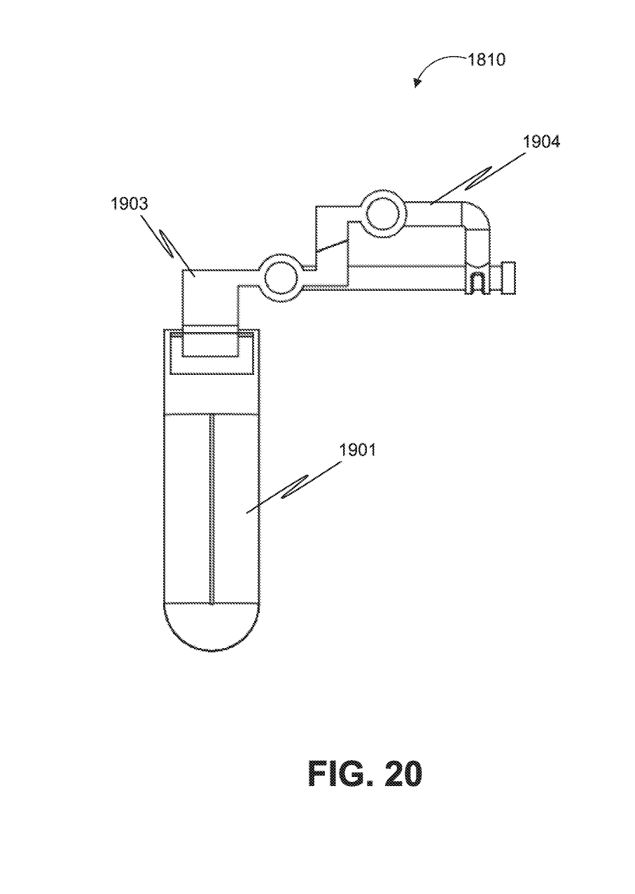

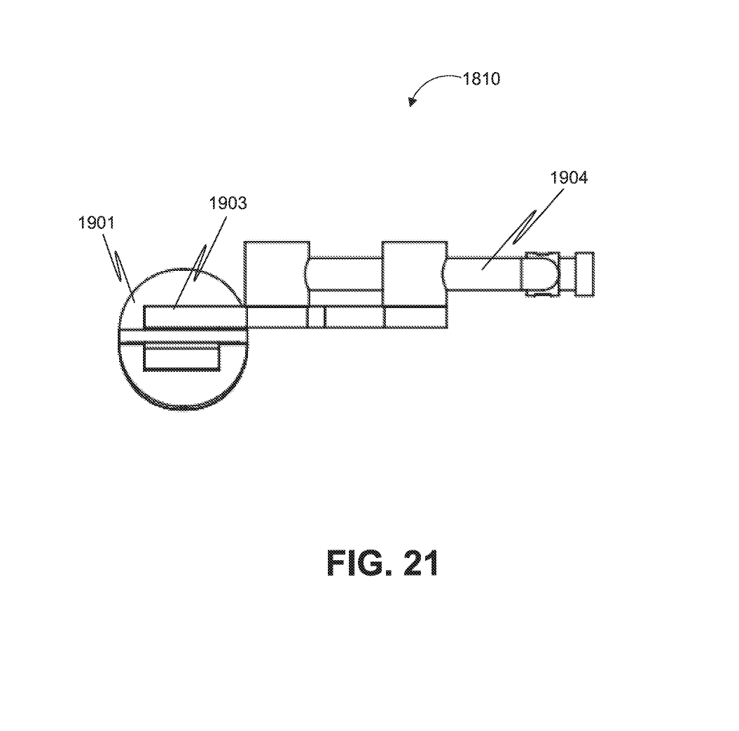

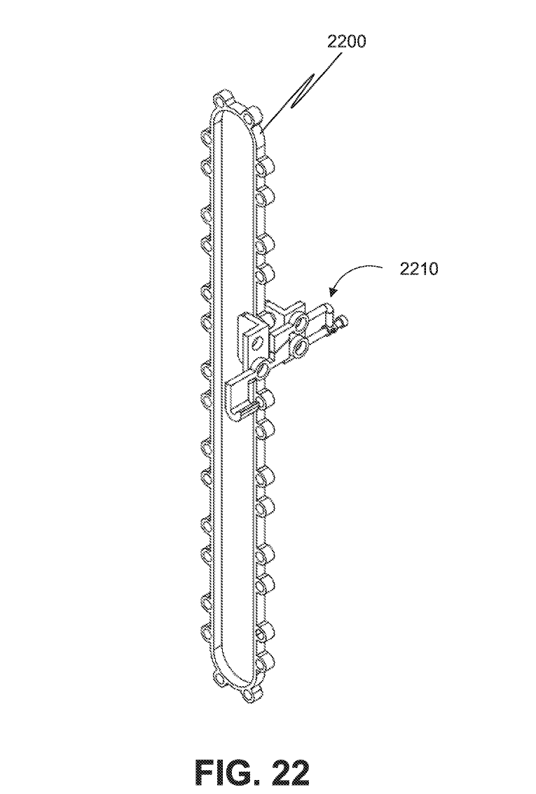

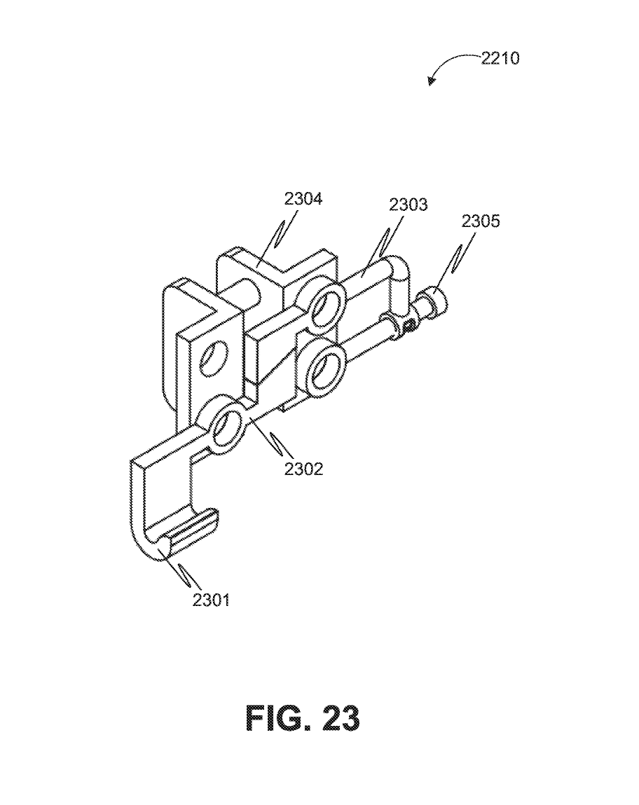

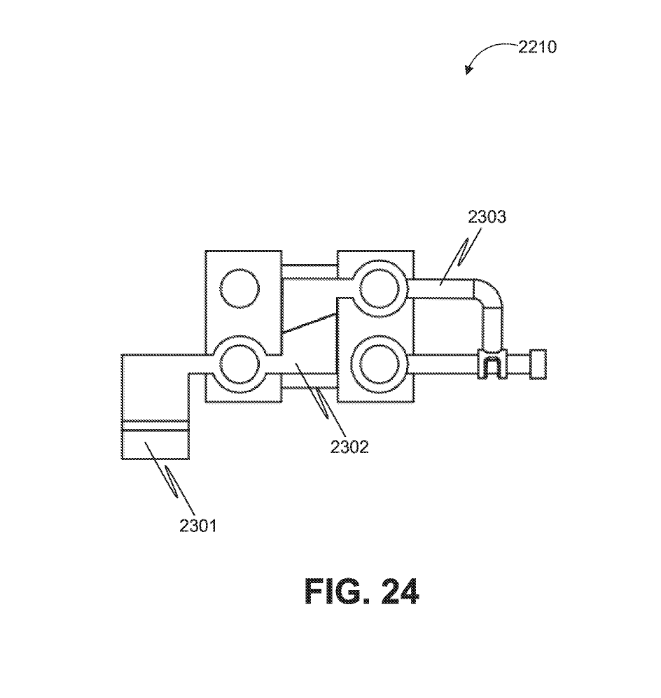

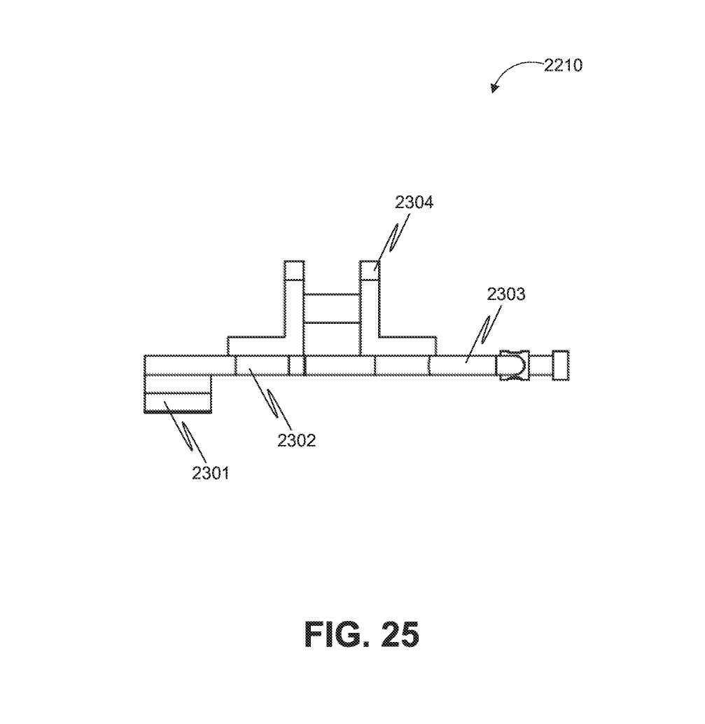

Alternative embodiments for the counterweight arrangement 1701 depicted in FIG. 17, may be incorporated into the alternative embodiment of the gravity motor. A counterweight arrangement is depicted in FIGS. 18 through 21. An alternative counterweight system is depicted in FIGS. 22 through 25 will eliminate the need for counterweights to be attached to the weight attachment chain of the alternative embodiment of the gravity motor. With reference to FIGS. 18 through 21, both counterweight arrangements utilize a principle of balancing the mass of a weight 1901 across the horizontal length of a weight attachment chain 1800 using an extended pin 1905, push arm 1904 and hook arm 1903. The components of the counterweight arrangement depicted in FIGS. 18 through 21 are loosely fastened to one another to prevent unwanted rotations when the assembly rotates along the weight attachment chain 1800. In other words, the counterweight arrangement, whether upside down or right side up, remains intact. The components of the alternative counterweight arrangement depicted in FIGS. 22 through 25 are affixed to an attachment link. The mass of the weight pulls down on the hook 2301 of the hook arm 2302, which rotates in the counter-clockwise direction to engage and push up on the push arm 2303, which then rotates in the clockwise direction to engage with the extended pin 2305. It is important to note that the extended pin in the alternative counterweight arrangement depicted in FIGS. 22 through 25 is stationary, meaning it does not rotate. Further, the hooks, pegs, and handles of the weight transfer components of either embodiment may have sound dampening or absorbing material integrated within. For example, the contact surfaces of the aforementioned components may further comprise foam, rubber, cloth or like materials to reduce the noise made during the machines operation.

With reference to FIG. 12, another preferred embodiment of the gravity motor 1000 is provided with a lubrication system comprising oil pans 1296, at least one oil tank, splash guards, and oil or other machine lubricant. Oil pans 1296A & 1296B are disposed below each of the first transfer sprockets of the lower sets of transfer sprockets. The oil pans are connected to the horizontal frame post braces. The oil pans are supplied with oil from an oil tank 1290, which may be situated below the oil pans on a secondary set of horizontal frame post braces. The oil pans are partially or completely filled with the oil. The oil pans are configured so the first transfer sprockets are partially submerged in the oil without interfering with the transfer sprocket axles. As a result, the drive chains pass through the oil, thus becoming lubricated in order to reduce wear from constant contact with the first transfer sprockets and the drive sprockets. The oil pans also serve to catch any lubricant that drips from the drive chains or other components. When the transfer sprockets dip into the oil pans, overflow can occur. For this reason, the oil pans can have an additional, larger pans 1796A & 1796B arranged at the base to catch any oil that is overflowing as depicted in FIG. 17. The over-flow oil can then be funneled and transferring by tubes back into the large oil tank 1790 for recycling as opposed to the oil ending up on the floor. The splash guards (not shown in figures) are mounted to the frame plates and extend therefrom to be positioned around the drive chains and the weight attachment chains. The splash guards catch and collect oil runoff and splash in order to direct it into the oil pans. Additionally, in order to lubricate the weight attachment chains, the drive chain splash guards are connected to the weight attachment splash guards via downwardly oriented funnels. Oil runoff from the drive chains can then be funneled to the weight attachment chains. The weight attachment chain splash guards would funnel back into the oil tank. The splash guards also act as safety precautions by covering the moving chains, which may help prevent extraneous objects from becoming jammed between the chains and the sprockets. Additionally, magnetic rings can be applied throughout the oil system to act as a filter to catch any metal shavings or debris that may result from wear.

The oil tank may be constructed as two separate but fluidly connected oil tanks, one larger than the other. The large oil tank is situated above the small oil tank and the small oil tank is fluidly connected to the oil pans. The fluid pressure in the large oil tank is greater than or equal to the fluid pressure in the small oil tank beneath it during operation. The small oil tank is sealed via a floating piston that is filled with air and has a rubber seal around the edges with a weight on top that equals the pressure of the small tank system's operating level. The floating piston is connected to a mechanical arm affixed to a fulcrum to open a valve or gate which allows oil to flow from large tank into small tank which the flow is stopped by a sealed stop in the small tank that acts with the floating piston in preventing it to move further upwards due to the increased pressure of the larger tank. As oil is picked up by the drive chains or flowed out by connected piping of the smaller tank and is thus removed from the oil pans or small oil tank and piping, the fluid pressure in the small oil tank drops below operating levels and below the fluid pressure in the large tank. This pressure differential causes the valve or gate to open, allowing oil to flow into the small tank from the large oil tank. The pressure of the weighted seal forces the oil up through the piping which connects to the oil pans or forces the oil up through the routed piping where the piping is affixed to the frame and ends vertically above the transfer sprockets giving a constant pressurized flow of lubrication onto the transfer sprockets and then funneled back by the splash guards into the large oil tank for recycling. Oil flows until the pressures of the large and small oil tanks equalize, at which point the gate or valve closes. This process repeats cycling to create an automatic, closed loop lubrication system.

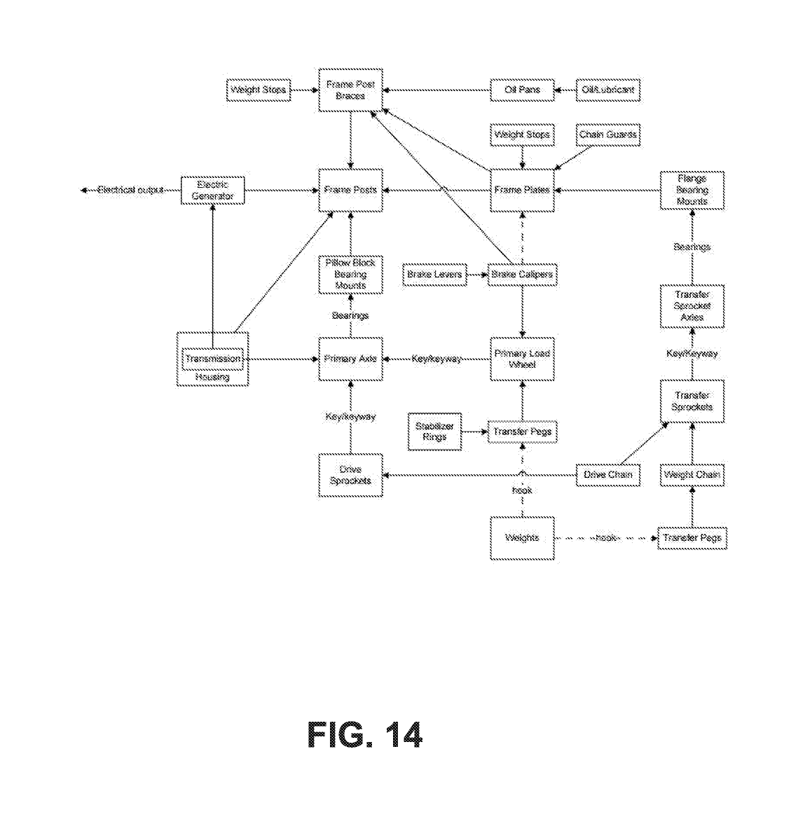

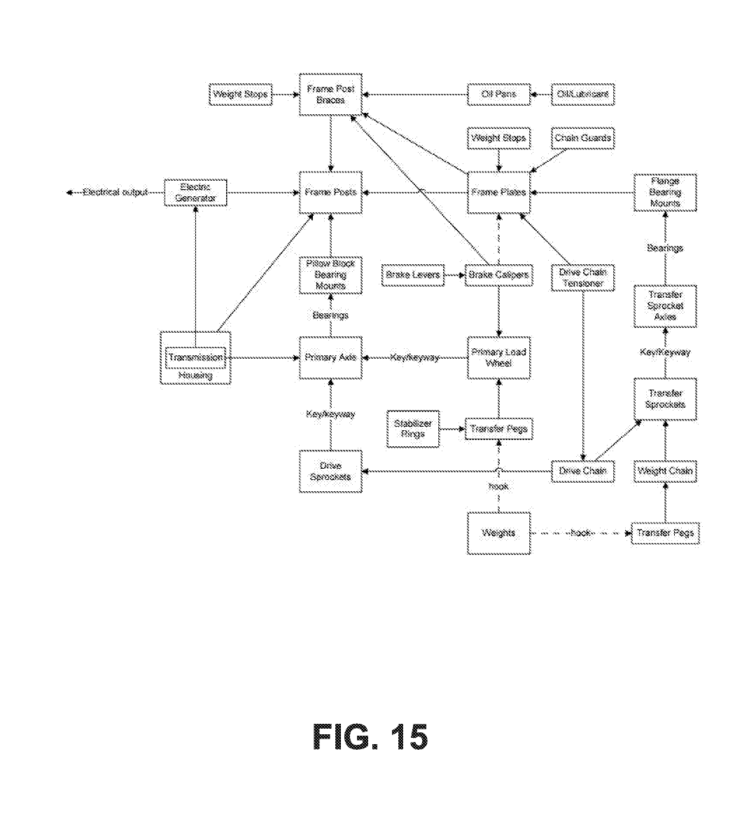

In the alternative embodiment of the present invention, a drive chain tensioner may be included for each drive chain, wherein each tensioner is mounted to one of the frame plate and is configured to engage the drive chains in order to keep them tensioned during operation. Additionally, a weight carrying chain tensioner may be included for each weight carrying chain, wherein the weight carrying chain tensioner can maintain a desired tension in the weight carrying chain during operation. However, in order to minimize frictional losses, it is desirable to not use a drive chain tensioner. FIG. 14 is a block diagram of the alternative embodiment, wherein connections between major components of the gravity motor are depicted. The block diagram in FIG. 15 depicts the connections between major components of the gravity motor including an added drive chain tensioner. It is important to note that both the preferred embodiment and alternative embodiment of the gravity motor can be arranged in many different configurations without departing from the scope and spirit of the invention. For example, altering the size of the drive sprocket of the alternative embodiment will require that a specific number of weights be integrated onto the weight chain, corresponding to the diameter or circumference of the drive sprocket in relation to the rotation of the primary load wheel and the distance from transfer point to transfer point in regards to the attachment path of the weights. For smaller drive sprockets, more weights may be needed to be utilized to provide the appropriate leverage to rotate the primary wheel, and vice versa. Another example is that the alternative embodiment of the gravity motor may adopt the location of the transfer sprockets of the preferred embodiment of the gravity motor. Meaning, the transfer sprockets are not limited to being directly above and below the primary axle. In doing so, the alternative embodiment would utilize the same principle of a load zone. Under this configuration, the drive sprocket may similarly vary in size, having the correct number of weights incorporated onto the weight chain to provide the appropriate leverage to rotate the primary load wheel. It is understood that for each variation, small changes in the accompanying components may have to be made to facilitate the new arrangement. For example, the hooks may be slighter longer to properly engage with the displacement of the weights in relation to the weight chain or primary load wheel, the weight attachment chain may comprise more or less weight attachment points, etc. These variations allow the transfer sprockets to be spinning at a slower rate which may help increase bearing life. Additionally, with regard to the preferred embodiment of the gravity motor, the location of the transfer sprockets as well as the catch/release points may be altered. In doing so, the weight attachment chain would have to be configured in size as well as the spacing for the attachments to accommodate the timing and rotation of the primary wheel. The various configurations of each embodiment impose the concept of utilizing weights on a wheeled device to create leverage, and thus providing rotational torque.

Although not depicted in the figures, a center sprocket may be arranged between the upper and lower transfer sprockets of the weight attachment chain to aid in altering the degree for advancing or retarding the timing of the gravity motor, in the preferred embodiment and/or the alternative embodiment of the gravity motor. In this regard, the center sprocket acts as an idler which can be mounted to a bearing via a flange mount or a bearing to the primary axle corresponding to the location of the transfer sprockets.

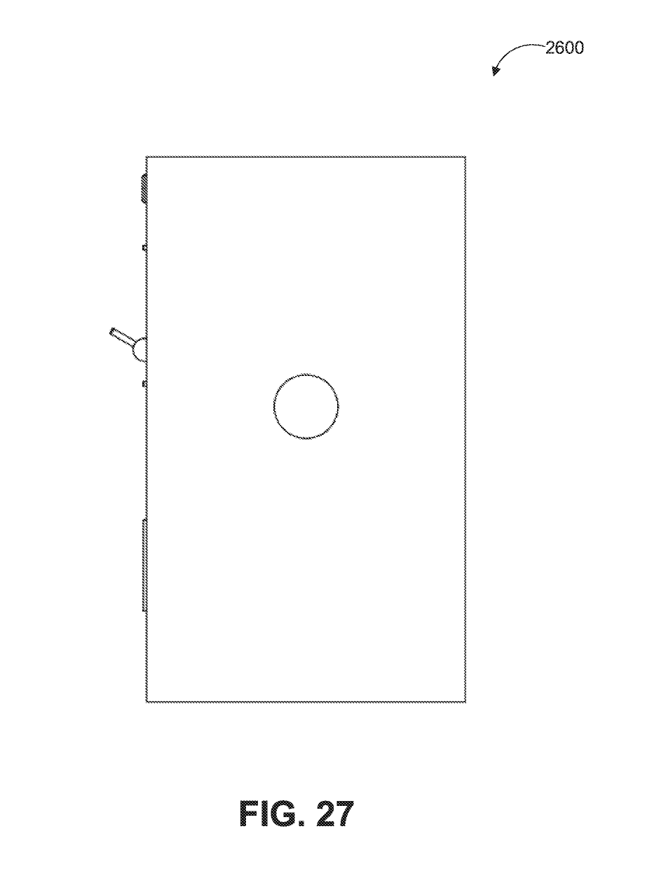

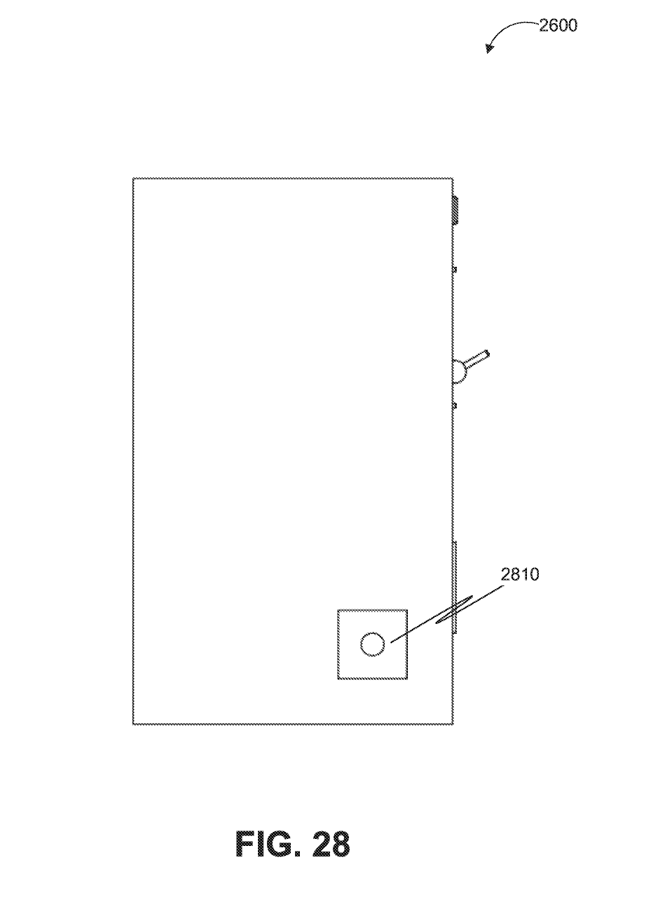

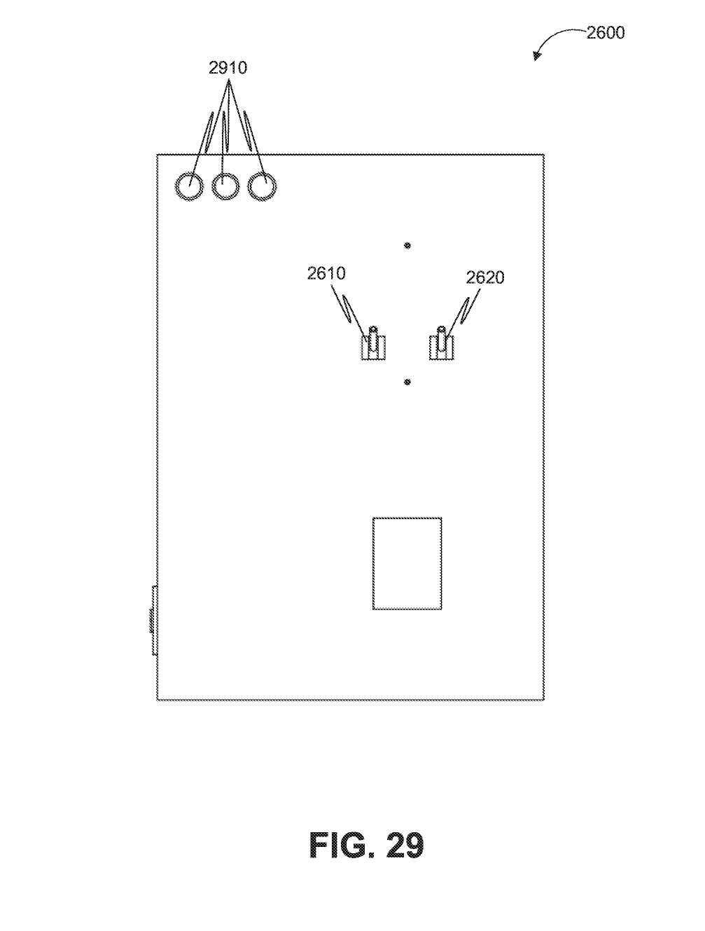

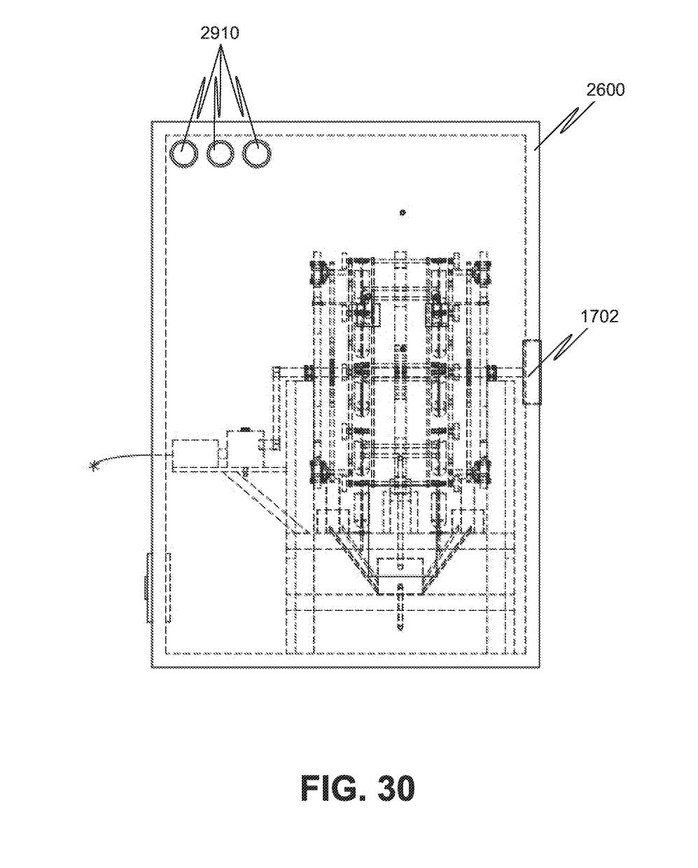

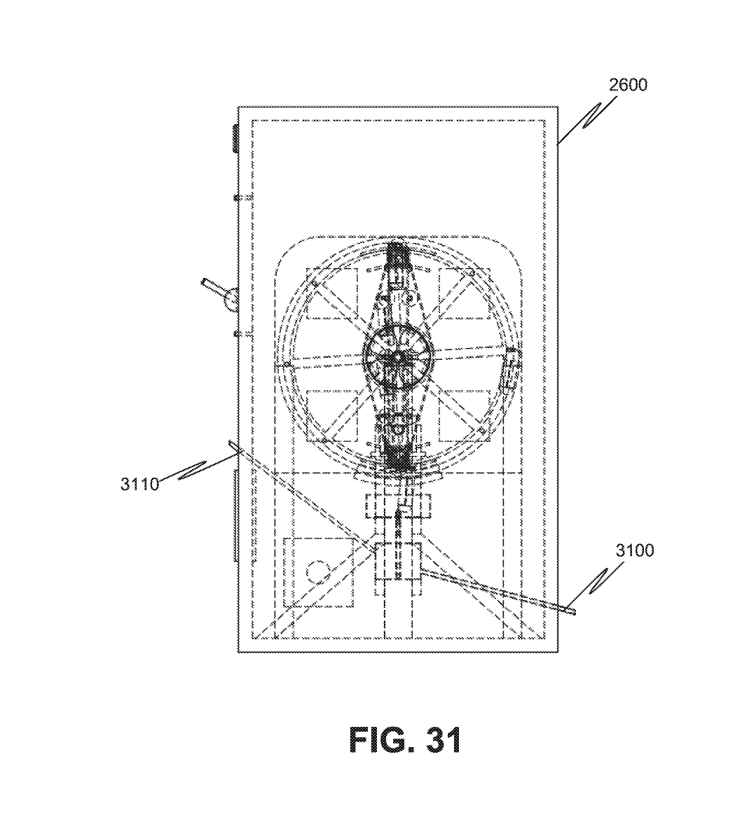

In yet another embodiment of the present invention, the gravity motor may be used within a specialized container system 2600. The gravity motor is enclosed in a sealed container system, as depicted in FIG. 30 and FIG. 31. Although the alternative embodiment of the gravity motor is depicted in the figures, either embodiment may utilize the sealed container. The container can be made from a variety of materials including, but not limited to plastic, drywall, metal, cinderblock or brick coated with a sealer. However, the material must allow for a seal. The sealed container is rectangular in shape and large enough to house at least one gravity motor. The sealed container comprises a plurality of ports, brake levers, sensors, grease fitting extensions, tubing/piping, a relief gate and an air filter/inlet. The ports are not limited to any specific location on the sealed container as long as they correspond to the components of the gravity motor that require them. The nipple or grease fitting extends through a rubber grommet and out of the sealed container system through various ports. FIG. 27 and FIG. 28 shows two grease fittings 2610 & 2620 protruding from the side surface of the sealed container 2600. One end of the tubing or piping is concentrically arranged onto the grease fitting within the sealed container. The other end is attached to various components of the gravity motor that needs to be greased (i.e. bearings) through grease fitting extensions/tubing. This facilitates the maintenance process for the gravity motor. The user can inject grease into the grease fittings to lubricate various components without having to open the sealed container. Additionally, tubing is to be arranged such that the user can add and remove oil from the oil tank. As depicted in FIG. 31, tubing 3100 extends from outside of the sealed container and into the oil tank on one side and tubing 3110 extends from inside the oil tank and out of the sealed container on the opposite side. A fan or turbine 1702 can be mounted on an available side on the primary axle of a gravity motor, as depicted in FIG. 30. A vacuum port 2810 can be arranged anywhere on the sealed container to allow air in through an air filter to create a vacuum within the system generated by the fan or turbine. A vacuum port 2810 is depicted on FIG. 28. The vacuum or blower ports may have interchangeable connections to make the ports larger or smaller which will increase or decrease the vacuum within the system. These interchangeable connections will have additional connections themselves via a clamp-on, slip-on, bolt-on or with a gasket, which can then be routed accordingly via a series of more connections and tubing. This container system allows for the incorporation of various monitoring devices such as gauges that can monitor the temperature and vacuum pressure. A plurality of gauges 2910 are depicted on the top left corner of the sealed container in FIG. 29. Additionally, the user can digitally analyze the heat from key heat generating components such as the bearings via a camera that detects infrared or thermal imaging. This data can be sent wirelessly or through a wired connection to a mainframe computer or terminal to allow the user to monitor the operating conditions of the gravity motor. Ideal software is needed for this application to function. This software would include indicators and warnings for when temperatures, pressures, and generated voltages are out of their normal and ideal operating ranges. This will notify the user monitoring the system that the gravity motor is in need of maintenance. The software may also be programmed to control on/off cycles of the motor and attached equipment such as the brakes and jam rod in accordance with the charge levels of the batteries which would help increase longevity of the gravity motor's parts. The sealed container is not limited to any specific size. A larger sealed container system may house a plurality of gravity motors. In the case of a much larger sealed container, a sealing door can be arranged onto a side of the container so that the user can enter and exit for any maintenance, monitoring, etc. In yet another embodiment of the present invention, the sealed container may further comprise wheels, like that of a trailer. In this embodiment, the sealed container, and thus the gravity motors will be portable. Under this configuration the system may be used as a portable generator, detachably hitched to a vehicle or the like.

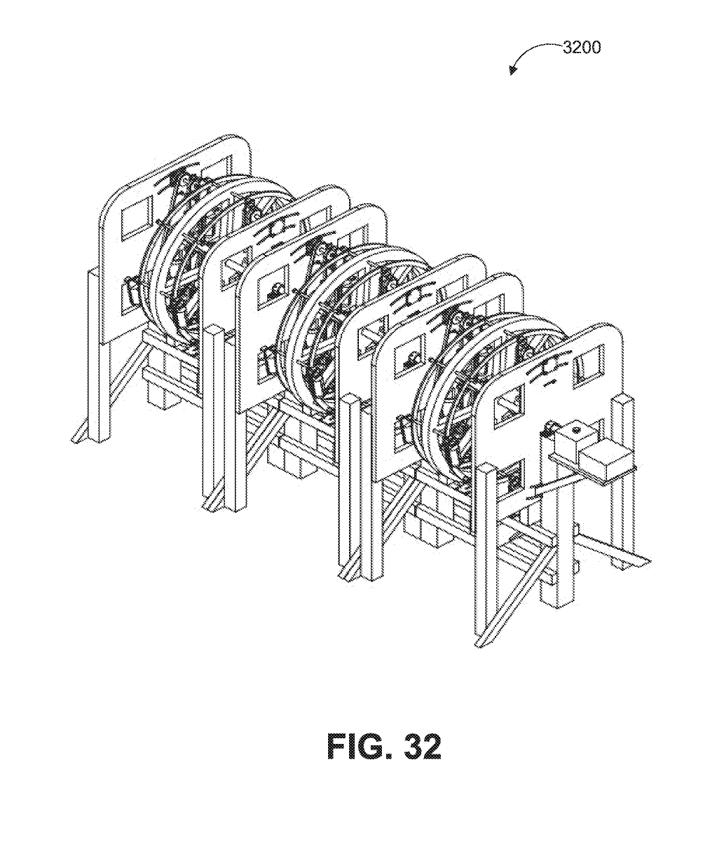

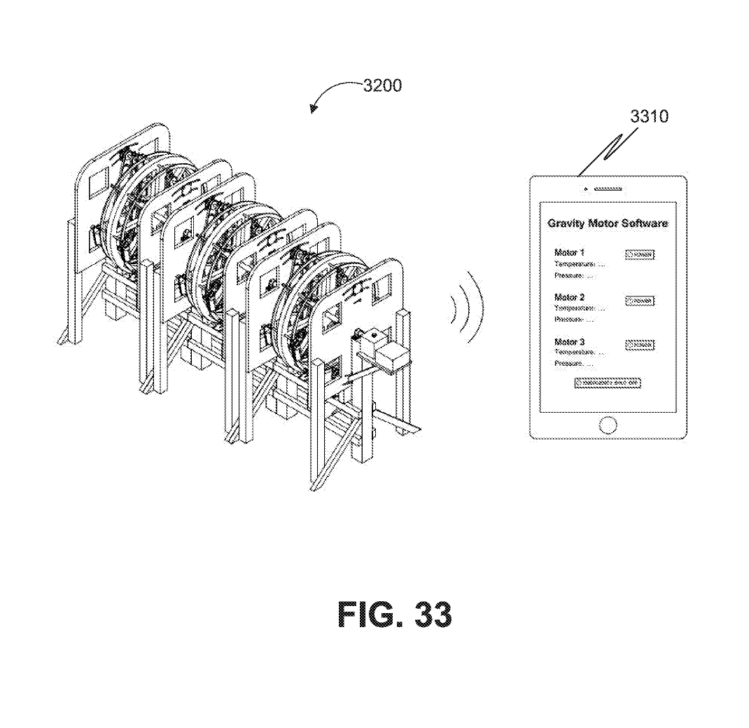

A plurality of motors can be fixed to a single axle or axles coupled together allowing the use of a single generator or alternator designed to work with the output of the entire system, as depicted in FIG. 32. A plurality of motors can be connected to a mainframe computer with relays. In case of a single machine shutdown, a single motor can be shut off via a brake lever or electrically shut down through an electrical/mechanical connection to operate the aforementioned lever for the brake to engage and disengage. The relay allows for the other motors to continue operating while one or more are shut off. The motors or units will all be numbered and digitally shown on the mainframe computer or terminal through the software. This system is depicted in FIG. 33. The series of machines as a whole can have their electrical output sent to a power distribution unit to allow for a single output wire consisting of a ground wire for safety. This single output wire then can be fixed accordingly to the power grid. Additionally, the series of machines can be shut off as a whole with an emergency brake override through a wired or wireless (via WIFI, Bluetooth, IR or the like) connection. The operator will be able to shut off the entire system through a computer, tablet or phone in case of an emergency. Alternatively, each motor can have an individual axle with a series of generators or alternators connected to a power distribution unit.

The generator or alternator that the gravity motors provide rotational torque to can be engaged and disengaged from its gear connection via a lever, resulting in the gears no longer intermeshing. Alternatively, gear belts may be used to transfer the power to the generator or alternator. This eliminates the need for a gear to gear connection with oil acting as a lubricant. The generator or alternator can be disconnected from the belt by changing its location, thus removing tension from the belt. The output power from the generator or alternator can be monitored via a voltmeter. The readings will then be sent to the mainframe computer for monitoring. Rechargeable batteries along with a battery charge controller and relay can be incorporated within the system to allow for the storage of excess power to later be used. For example, additional power or energy may be required during peak hours of operation. The system would constantly charge the batteries in conjunction with a battery charge controller to prevent over and undercharging and a relay for the excess power, which the batteries can act as a back-up source to send its stored energy out to the grid or desired application such as a house, building, etc. Additional geared connections can be made or coupled to the primary axle(s) of the system to power applications such as fans, propellers, turbines, pumps, generators, alternators, etc. These connections can be quickly engaged and disengaged via a mechanical or electromechanical lever to allow more output power to the other side of the axle's desired application and vice versa. Further, in either main embodiments of the present invention, the primary load wheel may have a belt or chain wrapped around its outer surface to drive the generator or alternator having a properly matched gear, sprocket and necessary components for its operation and output. In essence, the primary load wheel itself would be attached to a generator as opposed to the primary axle. In this regard, a generator with a smaller gear may be utilized, causing it to spin much faster due to the increased diameter of the primary load wheel over the primary axle, thus aiding in its output. The generator may be linked with a variable resistor or the like to imply a controlled variable load to the generator's circuitry to keep the gravity motor at a desired operating speed while the excess power is then stored to the batteries to be later used as needed.

The gravity motor is not limited to any specific size. The gravity motor will simply be larger or smaller in scale. Larger gravity motors can generate more power or torque due to the increase in mass, which is allowed by the increase in available surface area. The increase in torque for larger motors is due to the fact that the center of gravity is at a further distance from the center axle, or fulcrum point on the x-axis. In addition, larger gravity motors will allow for a smoother operation as the distance from TDC (Top Dead Center) to BDC (Bottom Dead Center) and the overall arc length of the weight's travel path increases. The energy fluctuations of the gravity motor may not be rapid as the weight shifts will take longer to reach each transfer point with the increase in distance.

With regard to linking multiple gravity motors together via a single axle as depicted in FIG. 32, each gravity motor may be mounted to start at different degrees. In other words, there is no specific starting point that each motor must start at in terms of the angular displacement of the primary load wheel. By varying the degrees in which the motors are attached decreases the fluctuations in the output and gives it more of a straight or constant torque curve on the graph, especially if all degrees of the load zone are represented.

Although the invention has been explained in relation to its preferred embodiment and alternative embodiment, it is to be understood that many other possible modifications and variations can be made without departing from the spirit and scope of the invention.

1. A gravity motor configured to generate rotational torque, the gravity motor comprising:
a. a frame structure configured to support the gravity motor on a base, wherein the frame structure comprises a first frame plate and a second frame plate;
b. at least one primary axle supported by each of the first frame plate and the second frame plate;
c. at least one primary load wheel positioned on the at least one primary axle, wherein the at least one primary load wheel is equidistant from each of the first frame plate and the second frame plate, wherein a first side of the at least one primary load wheel is positioned on the at least one primary axle between the at least one primary load wheel and the first frame plate, wherein a second side of the at least one primary load wheel is positioned on the at least one primary axle between the at least one primary load wheel and the second frame plate, wherein each of the first side and the second side of the at least one primary load wheel comprises arms with slots extending from a central location to allow weights to slide along the at least one primary load wheel;
d. a plurality of upper rotatable drive members and a plurality of lower rotatable drive members, wherein each of the plurality of upper rotatable drive members and a plurality of lower rotatable drive members is fixed to a corresponding transfer sprocket axle, wherein at least one end of the transfer sprocket axle of each of the plurality of upper rotatable drive members and the plurality of lower rotatable drive members is rotatably mounted to at least one of the first frame plate and the second frame plate via a flange mounted bearing, wherein a first upper transfer sprocket of the plurality of upper rotatable drive members and a first lower transfer sprocket of the plurality of lower rotatable drive members are positioned on a first side of the at least one primary load wheel, wherein a second upper transfer sprocket of the plurality of upper rotatable drive members and a second lower transfer sprocket of the plurality of lower rotatable drive members are positioned on a second side of the at least one primary load wheel; and
e. a plurality of weight attachment units, wherein a weight attachment unit of the plurality of weight attachment units is affixed to each of an upper transfer sprocket and a lower transfer sprocket, wherein each weight attachment unit is configured to hook the weights sliding along at least one of the first side of the at least one primary load wheel and the second side of the at least one primary load wheel, wherein each weight attachment unit is positioned between a side of the at least one primary load wheel and a frame plate, wherein the side is at least one of the first side and the second side, wherein the frame plate is at least one of the first frame plate and the second frame plate.

2. The gravity motor of claim 1, wherein the at least one primary axle is operatively coupled to an electric generator configured to generate electricity based on rotatory motion of the at least one primary axle transferred to the electric generator through a transmission.

3. The gravity motor of claim 1, wherein the frame structure further comprises a plurality of vertical frame posts, wherein each of the first frame plate and the second frame plate lies in a vertical plane, wherein the first frame plate is spaced apart from the second frame plate, wherein each of the first frame plate and the second frame plate is supported on an outward facing surface of a corresponding vertical frame post of the plurality of vertical frame posts.

4. The gravity motor of claim 3, wherein the frame structure further comprises a plurality of horizontal braces, wherein the plurality of vertical frame posts corresponding to each of the first frame plate and the second frame plate comprises a center post and a two side posts, wherein the two side posts are symmetrically spaced about the center post, wherein at least one pair of horizontal frame post braces connects a center post of the first frame plate with the center post of the second frame plate.

5. The gravity motor of claim 3, wherein the frame structure further comprises a plurality of frame plate braces, wherein a frame brace connects to each of the first frame plate and the second frame plate.

6. The gravity motor of claim 4 further comprising a plurality of pillow blocks corresponding to a plurality of center posts, wherein a pillow block corresponding to a center post comprises a bearing configured to support an end of the at least one primary axle, wherein the at least one primary axle is horizontally oriented.

7. The gravity motor of claim 1, wherein the weights in the presence of gravity provide a driving force that unbalances the at least one primary load wheel causing the at least one primary load wheel to generate rotational torque in the at least one primary axle.

8. The gravity motor of claim 1, wherein each of the at least one primary load wheel and each weight attachment unit comprises a plurality hooks configured to attach with the weights, wherein the weights are hooked to and from each of the at least one primary load wheel and each weight attachment unit upon rotation of the at least one primary load wheel.

9. The gravity motor of claim 1, wherein each of the first side of the at least one primary load wheel and the second side of the primary wheel comprises a plurality of even numbered slots, wherein each slot is configured to be rotatably affixed with a weight.

10. The gravity motor of claim 9, wherein each weight comprises a plurality of handles configured to engage with the plurality of hooks of each of the at least one primary load wheel and each weight attachment unit.

11. The gravity motor of claim 10, wherein a first handle of the plurality of handles is affixed to a surface of a weight facing parallel to the at least one primary load wheel and a second handle of the plurality of handles is affixed to an opposing surface of the weight, wherein the first handle is configured to engage with the plurality of hooks of the at least one primary load wheel and the second handle is configured to engage with the plurality of hooks of a weight attachment unit.

12. The gravity motor of claim 1, wherein a weight attachment unit of the plurality of weight attachment units comprises at least one of a chain and a belt.

13. The gravity motor of claim 1, wherein the weights comprise a plurality of weight rods configured to engage with the slots.

14. A gravity motor configured to generate rotational torque, the gravity motor comprising:
a. a frame structure configured to support the gravity motor on a base, wherein the frame structure comprises at least one of a first frame plate and a second frame plate;
b. a primary axle supported by at least one of the first frame plate and the second frame plate;
c. a primary load wheel positioned medially on the primary axle, wherein the primary load wheel is equidistant from each of the first frame plate and the second frame plate;
d. a first drive sprocket and a second drive sprocket, wherein the first drive sprocket is positioned on the primary axle between the primary load wheel and the first frame plate, wherein the second drive sprocket is positioned on the primary axle between the primary load wheel and the second frame plate, wherein each drive sprocket is fastened to the primary load wheel;
e. a set of rotatable drive members comprising an upper set of rotatable drive members and a lower set of rotatable drive members, wherein each transfer sprocket is fixed to a corresponding transfer sprocket axle, wherein at least one end of the transfer sprocket axle of each of the set of rotatable drive members is rotatably mounted to at least one of the first frame plate and the second frame plate via a flange mounted bearing, wherein a first transfer sprocket of the set of rotatable drive members is fixed to the corresponding transfer sprocket axle in alignment with an associated drive sprocket of at least one of the first drive sprocket and the second drive sprocket, wherein a second transfer sprocket of the set of rotatable drive members is fixed to the end of the corresponding transfer sprocket axle opposite the flange mounted bearing;
f. a plurality of drive chains, wherein for each drive sprocket of the first drive sprocket and the second drive sprocket, a drive chain passes over each of the drive sprocket, the first transfer sprocket of the upper set of rotatable drive members and the first transfer sprocket of the lower set of rotatable drive members in meshed engagement; and
g. a plurality of weight attachment units, wherein for each drive sprocket of the first drive sprocket and the second drive sprocket, a weight attachment unit is connected in meshed engagement with the second transfer sprocket of an associated upper set of rotatable drive members and the second transfer sprocket of the associated lower set of rotatable drive members, wherein a weight attachment unit of the plurality of weight attachment units is configured to carry a plurality of weights.

15. The gravity motor of claim 14, wherein each of the weight attachment unit and the primary load wheel comprise a plurality of transfer pegs configured to attach with the plurality of weights, wherein the plurality of transfer pegs are evenly spaced along the circumference of each of the weight attachment unit and the primary load wheel.

16. The gravity motor of claim 14, the plurality of weights are configured to be transferred between the weight attachment chain and the primary load wheel, wherein through action of gravity, the plurality of suspended weights provide a driving force that unbalances the primary load wheel causing the primary load wheel to generate a rotational torque about the primary axle.

17. The gravity motor of claim 15, wherein the spacing between the plurality of transfer pegs are configured such that a plurality of transfer pegs of the primary load wheel meet a plurality of transfer pegs of the weight attachment unit at each of a first point and a second point on at least one of the primary load wheel and a transfer sprocket, wherein a first weight of the plurality of weights is transferred from the weight attachment unit onto the primary load wheel at the first point, wherein a second weight of the plurality of weights is transferred back from the primary load wheel onto the weight attachment unit at the second point.

18. The gravity motor of claim 14, wherein a weight attachment unit of the plurality of weight attachment units comprises at least one of a chain and a belt.

19. The gravity motor of claim 14 further comprising at least one drive chain tensioner associated with at least one drive chain of the plurality of drive chains, wherein a drive chain tensioner is mounted to at least one of the first frame plate and the second frame plate, wherein the drive chain tensioner is configured to engage with a drive chain in order to maintain tension during operation of the gravity motor.

20. The gravity motor of claim 14 further comprising at least one weight attachment chain tensioner associated with at least one weight attachment chain of the plurality of weight attachment chains, wherein a weight attachment tensioner is mounted to at least one of the first frame plate, the second frame plate and the primary axle, wherein the weight attachment chain tensioner is configured to engage with a weight attachment chain in order to maintain tension during operation of the gravity motor.

21. The gravity motor of claim 14, wherein a weight of the plurality of weights comprises at least one of a suspended weight and a weight rod, wherein the weight rod is configured to engage with a slot in the primary load wheel.

22. The gravity motor of claim 14, wherein a number of the plurality of weights is based on a diameter of at least one of the first drive sprocket and the second drive sprocket.
